(19) United States
(12) Patent Application Publication
(10) Pub. No.: US 2026/0266861 A1
(43) Pub. Date: Sep. 10, 2026

(54) AUTOMATED ANALYZER, REAGENT BOTTLE, AND REAGENT BOTTLE ADAPTER

(71) Applicant: CANON MEDICAL SYSTEMS CORPORATION, Otawara-shi (JP)

(72) Inventors: Shozo HASHIMOTO, Nasushiobara (JP); Yasuo AKIZAWA, Nasushiobara (JP); Masahiro MASUBUCHI, Yaita (JP); Yuki YASUDA, Itami (JP)

(73) Assignee: CANON MEDICAL SYSTEMS CORPORATION, Otawara-shi (JP)

(21) Appl. No.: 19/552,636

(22) Filed: Feb. 27, 2026

(30) Foreign Application Priority Data
Mar. 6, 2025 (JP) 2025-035267

(51) Int. Cl. G01N 35/10; B01L 3/00

(52) U.S. Cl. CPC G01N 35/1002; B01L 3/523; G01N 35/1009; B01L 2200/026; B01L 2200/16; B01L 2300/0832

(57) ABSTRACT

An automated analyzer according to an embodiment performs analysis by mixing a reagent into a test sample to be analyzed, and includes an analyzing device and processing circuitry. The analyzing device includes a reagent bottle holding unit, a transfer mechanism, and a reagent probe. The reagent bottle holding unit stores one or more reagent bottles in each of which the reagent is stored. The transfer mechanism transfers the one or more reagent bottles to the reagent bottle holding unit. The reagent probe dispenses the reagent in the one or more reagent bottles. The processing circuitry controls a component included in the analyzing device, at least when analysis of the test sample is performed. The reagent bottle includes an opening/closing mechanism configured to open or close an opening portion into which the reagent probe is to be inserted when the reagent is dispensed. The processing circuitry changes a state of the opening/closing mechanism to an opened state or a closed state by controlling the transfer mechanism.

### CROSS-REFERENCE TO RELATED APPLICATIONS

This application is based upon and claims the benefit of priority from Japanese Patent Application No. 2025-035267, filed Mar. 6, 2025, the entire contents of which are incorporated herein by reference.

### FIELD

Embodiments of the present application relate to an automated analyzer, a reagent bottle, and a reagent bottle adapter.

### BACKGROUND

Conventionally, in fields such as specimen testing, automated analyzers have been used to automatically analyze test samples, such as specimens to be analyzed. In such automated analyzers, a plurality of reagent bottles preliminarily storing reagents are stored in a reagent bottle reagent holding unit, such as a reagent rack. Then, the automated analyzer selects a reagent bottle storing the reagent to be used in analysis, from among the reagent bottles accommodated in the reagent bottle reagent holding unit, and mixes the reagent in the selected reagent bottle with a test sample to perform the analysis of the test sample. Meanwhile, in the conventional automated analyzer, when the analysis of the test sample is performed, an operator who performs analysis opens a cap provided at an opening portion of each reagent bottle stored in the reagent bottle reagent holding unit, and then starts the analysis of a test sample by operating the automated analyzer. Then, after the analysis of the test sample is ended by the automated analyzer, the operator closes the cap of each reagent bottle. In other words, in the conventional automated analyzer, while the analysis of the test sample is being performed, the cap of the opening portion of the reagent bottle is always in an opened state in which the cap is opened. This raises concerns that reagents in reagent bottles left open may evaporate, causing the reagent to become concentrated, or that other reagents may become mixed through airborne contamination, leading to degradation in reagent quality.

In this regard, proposals have been made to provide a cap member or an opening/closing mechanism capable of automatically opening and closing the opening portion of a reagent bottle, in the reagent holding section such as a reagent rack or in the reagent bottle itself. However, in a case where an opening/closing mechanism that opens and closes an opening portion of a reagent bottle is provided in a reagent bottle reagent holding unit, the opening/closing mechanism is provided for each reagent bottle that can be accommodated. This requires a place (space) for the opening/closing mechanism and results in a more complex structure and higher cost of the reagent bottle reagent holding unit. Furthermore, when a reagent bottle equipped with an opening/closing mechanism is cleaned and refilled with a reagent different from the reagent previously contained, from the viewpoint that, for example, the possibility of reagent contamination becomes higher or the viewpoint that a malfunction of the opening/closing mechanism may occur, it becomes necessary to pay attention to cleaning the reagent bottle equipped with the opening/closing mechanism and to avoid refilling the same reagent bottle with a different reagent. These requirements become factors that complicate the operation of the automated analyzer.

### BRIEF DESCRIPTION OF THE DRAWINGS

FIG. 1 is a block diagram illustrating an example of a configuration of an automated analyzer according to an embodiment;

FIG. 2 is a block diagram illustrating an example of a configuration of an analyzing device included in the automated analyzer according to an embodiment;

FIGS. 3A-1 to 3B-3 are diagrams illustrating an example of a structure and an opening/closing operation of an opening/closing mechanism of a reagent bottle according to the first embodiment;

FIGS. 4A to 4D are diagrams illustrating an example of a structure and an opening/closing operation of an opening/closing mechanism of a reagent bottle according to the first embodiment;

FIGS. 5A-1 to 5C are diagrams illustrating an example of a structure and an opening/closing operation of an opening/closing mechanism of a reagent bottle according to the first embodiment;

FIGS. 6A to 6C are diagrams illustrating an example of a structure and an opening/closing operation of an opening/closing mechanism of a reagent bottle according to the first embodiment;

FIGS. 7A to 7C are diagrams illustrating an example of a structure and an opening/closing operation of an opening/closing mechanism of a reagent bottle according to the first embodiment;

FIGS. 8A and 8B are diagrams illustrating an example of a structure and an opening/closing operation of an opening/closing mechanism of a reagent bottle according to the first embodiment; and

FIGS. 9A-1 to 9B-2 are diagrams illustrating an example of a structure and an opening/closing operation of an opening/closing mechanism of a reagent bottle according to the first embodiment.

### DETAILED DESCRIPTION

An automated analyzer according to an embodiment performs analysis by mixing a reagent into a test sample to be analyzed, and includes an analyzing device and processing circuitry. The analyzing device includes a reagent bottle holding unit, a transfer mechanism, and a reagent probe. The reagent bottle holding unit stores one or more reagent bottles in each of which the reagent is stored. The transfer mechanism transfers the one or more reagent bottles to the reagent bottle holding unit. The reagent probe dispenses the reagent in the one or more reagent bottles. The processing circuitry controls a component included in the analyzing device, at least when analysis of the test sample is performed. The reagent bottle includes an opening/closing mechanism configured to open or close an opening portion into which the reagent probe is to be inserted when the reagent is dispensed. The processing circuitry changes a state of the opening/closing mechanism to an opened state or a closed state by controlling the transfer mechanism.

Various Embodiments will be described hereinafter with reference to the accompanying drawings.

Hereinafter, an automated analyzer, a reagent bottle, and a reagent bottle adapter according to an embodiment will be described with reference to the accompanying drawings. In the following description, for ease of recognition of each component, the scale and positional relationships of the components illustrated in the drawings are appropriately changed.

The automated analyzer is a medical analyzing device that analyzes a sample to be analyzed (test sample), such as a specimen collected from a subject (e.g., a human body), by mixing a reagent stored in a reagent bottle with the test sample. The automated analyzer is not to be specifically limited by the analysis method, and includes a biochemical analyzer, a blood coagulation analyzer, an immunoassay device, and the like.

### Configuration of Automated Analyzer

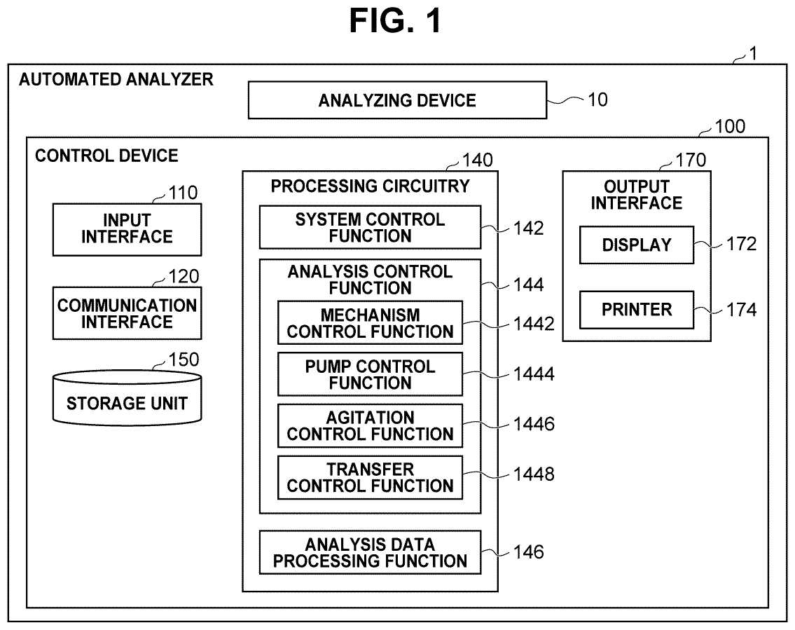

FIG. 1 is a block diagram illustrating an example of a configuration of an automated analyzer according to an embodiment. An automated analyzer 1 includes, for example, an analyzing device 10 and a control device 100. The analyzing device 10 is configured to analyze test samples and standard samples (calibrators) used for calibration. An example of a detailed configuration of the analyzing device 10 will be described below.

The control device 100 is configured to control the overall operations and processes to be executed when a test sample is analyzed in the automated analyzer 1 and operations of each component included in the analyzing device 10. The control device 100 includes, for example, an input interface 110, a communication interface 120, processing circuitry 140, a storage unit 150, and an output interface 170.

The input interface 110 is an operation unit to be operated by an operator who performs the analysis of a test sample using the automated analyzer 1. If the operator inputs settings for an analysis condition for analysis of a test sample, and various instructions to perform the analysis, for example, by operating the input interface 110 to perform the analysis of the test sample, the input interface 110 receives various input operations performed by the operator, and outputs electric signals and/or operation data that indicate details of the received input operations, to the processing circuitry 140. The input interface 110 is implemented by, for example, a mouse, a keyboard, a touch panel, a trackball, a switch, a button, a joystick, a camera, an infrared sensor, and a microphone. In a case where the input interface 110 is a touch panel, the input interface 110 may be formed integrally with a display device.

The communication interface 120 is a communication unit that communicates with an external apparatus (not illustrated) located outside the automated analyzer 1. The communication interface 120 includes a communication interface such as a network interface card (NIC), for example. The communication interface 120 communicates with external equipment and/or an external apparatus via a network (not illustrated) such as a local area network (LAN), and transmits analysis data or the like that has been obtained through analysis executed by the automated analyzer 1, to the external equipment or the external apparatus.

The processing circuitry 140 controls the overall operations and processes executed by the automated analyzer 1, and operations of each component that are executed when the analyzing device 10 analyzes a test sample, in accordance with the electric signals and operation data that indicate the details of the input operations output by the input interface 110 that has received operations performed by the operator. The processing circuitry 140 processes analysis signals, derived from the test sample, that have been output by the analyzing device 10 to generate analysis data indicating an analysis result of a test sample. The processing circuitry 140 executes, for example, a system control function 142, an analysis control function 144, an analysis data processing function 146, and the like. The analysis control function 144 executes, for example, a mechanism control function 1442, a pump control function 1444, an agitation control function 1446, a transfer control function 1448, and the like.

For example, the processing circuitry 140 causes a hardware processor to execute programs (software) stored in a not-illustrated memory (may be the storage unit 150) to implement each function such as the system control function 142, the analysis control function 144 (including the mechanism control function 1442, the pump control function 1444, the agitation control function 1446, and the transfer control function 1448), and the analysis data processing function 146. The memory (not illustrated) is implemented by, for example, a semiconductor memory device, such as a read only memory (ROM), a random access memory (RAM), or a flash memory, a hard disk drive (HDD), or an optical disk.

The hardware processor means circuitry such as, a central processing unit (CPU), a graphics processing unit (GPU), a large scale integration (LSI) circuit, a system on chip (SOC), an application specific integrated circuit (ASIC), or a programmable logic device (e.g., a simple programmable logic device (SPLD), a complex programmable logic device (CPLD), or a field programmable gate array (FPGA)). Instead of storing programs into the memory (not illustrated), programs may be directly incorporated in circuitry of the hardware processor. In this case, the hardware processor reads and executes a corresponding program incorporated in the circuitry to implement each function. The hardware processor is not limited to being configured as a single piece of circuitry, and may be configured as a hardware processor combining a plurality of pieces of independent circuitry, to realize each function. A plurality of components may be integrated into one hardware processor, and each function may be implemented. A plurality of components may be incorporated in one piece of dedicated LSI circuitry to implement each function. Here, programs (software) may be prestored in a storage device constituting a storage device, such as a semiconductor memory device such as a ROM, a RAM, or a flash memory, or an HDD (a storage device including a non-transitory storage medium (may be the storage unit 150)), or may be stored in a removable storage medium (non-transitory storage medium) such as a digital versatile disc (DVD) or a compact disk read only memory (CD-ROM), and installed in a storage device (may be the storage unit 150) included in the automated analyzer 1, by the storage medium being attached to a drive device included in the automated analyzer 1. The programs (software) may be preliminarily downloaded from another computer apparatus via a network (not illustrated), and installed on a storage device (may be the storage unit 150) included in the automated analyzer 1. A program (software) installed on a storage device included in the automated analyzer 1 may be executed after being transferred to the processing circuitry 140 included in the automated analyzer 1.

The system control function 142 controls the overall operations and processing to be executed by the automated analyzer 1, in accordance with electric signals and operation data that indicate the details of the input operations output by the input interface 110.

The analysis control function 144 controls operations of each component included in the analyzing device 10, in accordance with electric signals and operation data that indicate the details of the input operations output by the input interface 110. The mechanism control function 1442 controls mechanisms for operating a first reagent storage 11, a second reagent storage 12, a reaction disk 13, a disk sampler 14, a first reagent dispensing arm 21, a second reagent dispensing arm 22, a sample reagent dispensing arm 23, and an agitation unit 41, all of which are included in the analyzing device 10, which will be described below. The pump control function 1444 controls operations of various pumps included in the analyzing device 10 (described below), such as a dispensing pump, a first reagent pump, a second reagent pump, a cleaning pump, and a drying pump. The agitation control function 1446 controls an operation of agitating a mixture by the agitation unit 41 included in the analyzing device 10, which will be described below. The transfer control function 1448 controls an operation of transferring a reagent bottle 16 using a reagent bottle loading device 50 included in the analyzing device 10, which will be described below. Furthermore, by the control of operations of the reagent bottle loading device 50, the transfer control function 1448 changes (shifts) the state of the reagent bottle 16 including an opening/closing mechanism to be described below, to an opened state or a closed state.

The analysis data processing function 146 performs predetermined processing on analysis signals, derived from the test sample, that have been output by the analyzing device 10 and generates analysis data indicating an analysis result of a test sample. The analysis data is calculated by performing predetermined calculation on the analysis signals using a calculation function, for example. The analysis data processing function 146 stores the generated analysis data in the storage unit 150. The analysis data processing function 146 outputs the generated analysis data to the output interface 170, thus presenting the analysis data to the operator.

The storage unit 150 stores the analysis signal derived from the test sample that have been output by the analyzing device 10, and the analysis data generated by the processing circuitry 140. The storage unit 150 is implemented by, for example, a semiconductor memory device, such as a ROM, a RAM, or a flash memory, an HDD, or an optical disk.

The output interface 170 presents the analysis data generated by the processing circuitry 140, or the analysis data stored in the storage unit 150, to the operator. The output interface 170 includes, for example, a display 172 and a printer 174.

The display 172 is a display unit that displays various types of information. For example, the display 172 displays an image representing the analysis data generated by the processing circuitry 140, and a graphical user interface (GUI) image for receiving various input operations of the operator. The display 172 is, for example, a liquid crystal display (LCD), a cathode ray tube (CRT) display, or an organic electroluminescence (EL) display.

The printer 174 is a printing unit that prints various types of information. For example, the printer 174 prints analysis data or the like that has been generated by the processing circuitry 140, on a printing medium (printer sheet) such as paper. The printer 174 may print an image displayed on the display 172. The printer 174 is, for example, a thermal transfer printer, a thermal printer, or an inkjet printer.

The automated analyzer 1 is an example of an “automated analyzer”. The analysis control function 144 (may be the transfer control function 1448) is an example of a “control unit”.

### Configuration of Analyzing Device

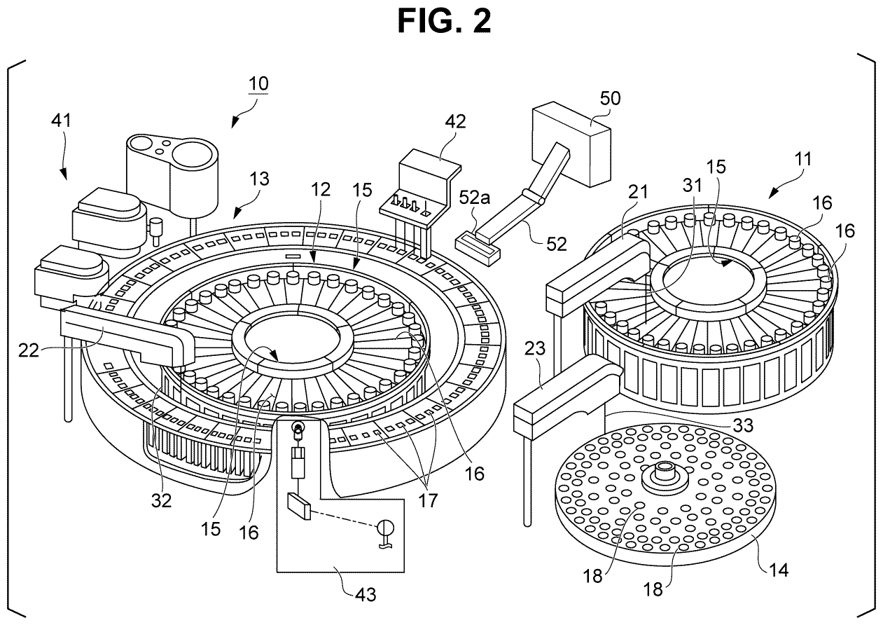

Next, an example of a configuration of the analyzing device 10 will be described. FIG. 2 is a block diagram illustrating an example of a configuration of the analyzing device 10 included in the automated analyzer 1 according to an embodiment. FIG. 2 is a perspective view of the analyzing device 10. The analyzing device 10 includes, for example, the first reagent storage 11, the second reagent storage 12, the reaction disk 13, and the disk sampler 14. FIG. 2 illustrates an example of the analyzing device 10 having a configuration that can accommodate a plurality of reagent bottles 16 storing reagents, but the number of reagent bottles 16 that can be accommodated in the analyzing device 10 may be one.

In a planar view, both the first reagent storage 11 and the second reagent storage 12 are circular. The first reagent storage 11 and the second reagent storage 12 are adjacently arranged at close positions. Reagent racks 15 are each accommodated in the first reagent storage 11 and the second reagent storage 12. In each reagent rack 15, a plurality of reagent bottles 16 (may be one reagent bottle 16) storing reagents is accommodated. In the first reagent storage 11, the reagent rack 15 in which the reagent bottles 16 storing first reagents are accommodated is stored, and in the second reagent storage 12, the reagent rack 15 in which the reagent bottles 16 storing second reagents are accommodated is stored. The first reagent and the second reagent selectively react with an analyte in a test sample or with a calibrator for the analyte. Each of the reagent bottles 16 includes an opening/closing mechanism of switching between the opened state in which an opening portion is opened and a closed state in which the opening portion is closed. Each reagent bottles 16 is accommodated in the reagent rack 15 with the opening portion kept in the closed state by the opening/closing mechanism. For example, each reagent bottle 16 may be a general-purpose reagent bottle equipped with a reagent bottle adapter that includes the opening/closing mechanism, thus forming a reagent bottle including the opening/closing mechanism. The reagent bottle 16 may be a dedicated reagent bottle integrated with an opening/closing mechanism, instead of using a general-purpose reagent bottle with a reagent bottle adapter. In the following description, unless otherwise clearly stated, the reagent bottles 16 are each assumed to be a general-purpose reagent bottle equipped with a reagent bottle adapter. An example of detailed configurations of the reagent bottle adapter and the opening/closing mechanism of the dedicated reagent bottle will be described below.

The reaction disk 13 is arranged to surround the second reagent storage 12. In the reaction disk 13, a plurality of reaction tubes 17 is arranged on the circumference in a circumferential direction. The reaction disk 13 rotates in the circumferential direction along the outer circumference of the second reagent storage 12.

The disk sampler 14 is arranged adjacent to the first reagent storage 11 and the second reagent storage 12, and aligned alongside each of the first reagent storage 11 and the second reagent storage 12. In the disk sampler 14, test sample containers 18, each storing a test sample and/or a calibrator, are set in the disk sampler 14.

The analyzing device 10 rotates the first reagent storage 11, the second reagent storage 12, and the disk sampler 14 in each cycle, under the control of the analysis control function 144 in the processing circuitry 140 included in the control device 100 (control executed by the mechanism control function 1442). The analyzing device 10 rotates the reaction disk 13 under the control of the mechanism control function 1442, and stops the first reagent storage 11, the second reagent storage 12, the reaction disk 13, and the disk sampler 14 at positions determined under the control of the analysis control function 144.

The analyzing device 10 further includes, for example, the first reagent dispensing arm 21, the second reagent dispensing arm 22, the sample reagent dispensing arm 23, a first reagent dispensing probe 31, a second reagent dispensing probe 32, and a sample reagent dispensing probe 33.

The first reagent dispensing arm 21 holds the first reagent dispensing probe 31 in such a manner that the first reagent dispensing probe 31 can pivot about a vertical axis and move vertically. The first reagent dispensing arm 21 can cause the first reagent dispensing probe 31 to pivot across the first reagent storage 11 and the reaction disk 13. The second reagent dispensing arm 22 holds the second reagent dispensing probe 32 in such a manner that the second reagent dispensing probe 32 can pivot about a vertical axis and move vertically. The second reagent dispensing arm 22 can cause the second reagent dispensing probe 32 to pivot across the second reagent storage 12 and the reaction disk 13. The second reagent dispensing arm 22 can move the second reagent dispensing probe 32 between two points on the outer circumference of the reaction disk 13. The sample reagent dispensing arm 23 holds the sample reagent dispensing probe 33 in such a manner that the sample reagent dispensing probe 33 can pivot about a vertical axis and move vertically. The sample reagent dispensing arm 23 can cause the sample reagent dispensing probe 33 to pivot across the reaction disk 13 and the disk sampler 14.

The analysis control function 144 in the processing circuitry 140 included in the control device 100 controls the pivoting and vertical movement of the first reagent dispensing probe 31 in the first reagent dispensing arm 21, the pivoting and vertical movement of the second reagent dispensing probe 32 in the second reagent dispensing arm 22, and the pivoting and vertical movement of the sample reagent dispensing probe 33 in the sample reagent dispensing arm 23, using the mechanism control function 1442.

The first reagent dispensing arm 21 and the second reagent dispensing arm 22 each include a height adjustment mechanism. The height adjustment mechanisms allow the first reagent dispensing arm 21 and the second reagent dispensing arm 22 to adjust a height (aspiration height) to be set when the first reagent dispensing probe 31 and the second reagent dispensing probe 32 each aspirate reagent in the reagent bottles 16.

In each cycle, the first reagent dispensing probe 31 aspirates a first reagent from the reagent bottle 16 located at a first reagent aspiration position in the first reagent storage 11, and dispenses the first reagent into a reaction tube 17 stopped at the first reagent dispensing position. In each cycle, the second reagent dispensing probe 32 aspirates a second reagent from the reagent bottle 16 located at a second reagent aspiration position in the second reagent storage 12, and dispenses the second reagent into the reaction tube 17 stopped at the second reagent dispensing position. The sample reagent dispensing probe 33 aspirates a test sample or a calibrator from the test sample container 18 at the position of the disk sampler 14 that has been controlled by the analysis control function 144, and dispenses the test sample or the calibrator into the reaction tube 17 stopped at a test sample dispensing position.

Probe sensors are provided at lower end portions of the first reagent dispensing probe 31, the second reagent dispensing probe 32, and the sample reagent dispensing probe 33. The probe sensors function as liquid level sensors that detect the height of a liquid level of liquid in the reaction tube 17, such as a mixture, a reagent, or a calibrator, by the leading ends of the first reagent dispensing probe 31, the second reagent dispensing probe 32, and the sample reagent dispensing probe 33 touching a liquid level.

The first reagent dispensing arm 21 and the second reagent dispensing arm 22 each can determine whether, when the reagent in a reagent bottle 16 is aspirated, an opening portion of the reagent bottle 16 is in the opened state, in other words, whether the reagent can be aspirated from the reagent bottle 16, or in the closed state in which the reagent cannot be aspirated from the reagent bottle 16. For example, an imaging apparatus, such as a camera, is provided at a position at which the first reagent dispensing probe 31 or the second reagent dispensing probe 32 is held, in each of the first reagent dispensing arm 21 and the second reagent dispensing arm 22. On the basis of an image of the leading end portion (lower end portion) of the first reagent dispensing probe 31 or the second reagent dispensing probe 32, captured by the imaging apparatus, including the opening portion of the reagent bottle 16, and the opening/closing mechanism included in the reagent bottle 16, it is possible to determine (check) whether the opening portion of the reagent bottle 16 is in the opened state. For example, it is possible to determine (check) whether the opening portion of the reagent bottle 16 is in the opened state, based on whether the probe sensors provided at the lower end portions of the first reagent dispensing probe 31 and the second reagent dispensing probe 32 touch an object other than the liquid level of the reagent stored in the reagent bottle 16, such as the opening/closing mechanism included in the reagent bottle 16.

When the first reagent dispensing arm 21 and the second reagent dispensing arm 22 are each controlled in such a manner as to aspirate the reagent from the reagent bottle 16, under the control of the analysis control function 144 in the processing circuitry 140 included in the control device 100, and it is determined (confirmed) that the opening portion of the reagent bottle 16 is in the closed state in which the reagent cannot be aspirated from the reagent bottle 16, due to, for example, an operation failure of the opening/closing mechanism or the like, the first reagent dispensing arm 21 and the second reagent dispensing arm 22 each output a notification indicating this, to the analysis control function 144. In a case where a notification indicating that it is determined (confirmed) that the opening portion of the reagent bottle 16 is in the closed state in which the reagent cannot be aspirated from the reagent bottle 16 is output from the first reagent dispensing arm 21 or the second reagent dispensing arm 22, the analysis control function 144 stops the analysis of the current test sample, and notifies the operator of this. In a case where a notification indicating that a reagent cannot be aspirated from the reagent bottle 16 is output from the first reagent dispensing arm 21 or the second reagent dispensing arm 22, the analysis control function 144 may start the analysis of a test sample using another reagent, without performing the analysis of a test sample using the reagent that cannot be aspirated from the reagent bottle 16 in the closed state, in other words, by skipping the analysis of the current test sample. Also in this case, the analysis control function 144 notifies the operator that the analysis of the current test sample has been skipped. Such a notification indicating that the opening portion of the reagent bottle 16 is determined to be in the closed state may be provided by, for example, displaying a notification image on the display 172, or by illuminating indicator (not illustrated, commonly referred to as a notification lamp) including a light-emitting element such as a light emitting diode (LED) provided in the control device 100.

The display 172 and the indicator (not illustrated) serve as an example of a “notification apparatus”.

The analyzing device 10 further includes, for example, the agitation unit 41, a cleaning unit 42, and a photometry unit 43. All of the agitation unit 41, the cleaning unit 42, and the photometry unit 43 are arranged around the reaction disk 13. The agitation unit 41 is arranged at an agitation position on the reaction disk 13, the cleaning unit 42 is arranged at a cleaning/drying position on the reaction disk 13, and the photometry unit 43 is arranged at a photometry position on the reaction disk 13.

The agitation unit 41 agitates a mixture of a test sample or a calibrator and a reagent, contained in the reaction tube 17 positioned at the agitation position. Examples of mixture combinations include a test sample and the first reagent; a test sample, the first reagent, and the second reagent; a calibrator and the first reagent; and a calibrator, the first reagent, and the second reagent.

The cleaning unit 42 aspirates mixture, having been subjected to measuring, in the reaction tube 17 stopped at the cleaning/drying position, and cleans and dries the inside of the reaction tube 17.

The photometry unit 43 measures the reaction tube 17 including a mixture, from the photometry position. The photometry unit 43 emits light to the rotationally-moving reaction tube 17 from a light source provided at the photometry position to measure changes in absorbance of the mixture, and outputs analysis signals or calibration signals, derived from the test sample or the calibrator, that have been obtained through the measurement, to the analysis data processing function 146 in the processing circuitry 140 included in the control device 100. After the measurement of the mixture is completed, the reaction tube 17 cleaned and dried by the cleaning unit 42 is used again for measurement.

The first reagent dispensing arm 21 is provided with a first reagent pump. The first reagent pump is used for aspirating the first reagent through the first reagent dispensing probe 31, and discharging the first reagent aspirated from the first reagent dispensing probe 31. The second reagent dispensing arm 22 is provided with a second reagent pump. The second reagent pump is used for aspirating the second reagent through the second reagent dispensing probe 32, and discharge the second reagent aspirated from the second reagent dispensing probe 32. The sample reagent dispensing arm 23 is provided with a sample reagent dispensing pump. The sample reagent dispensing pump is used for aspirating the test sample and the calibrator through the sample reagent dispensing probe 33, and discharging the test sample and calibrator aspirated from the sample reagent dispensing probe 33. The cleaning unit 42 is provided with a cleaning pump and a drying pump. The cleaning pump is used for supplying cleaning liquid for cleaning the inside of the reaction tube 17, from the cleaning unit 42, and aspirating the cleaning liquid. The drying pump is used for drying the inside of the cleaned reaction tube 17.

The aspiration and discharge operations of each of the first reagent pump, the second reagent pump, and the sample reagent dispensing pump are controlled by the analysis control function 144 in the processing circuitry 140 included in the control device 100, using the pump control function 1444. The aspiration and discharge operations of each of the cleaning pump and the drying pump, in other words, the cleaning and drying of the inside of the reaction tube 17, are controlled by the pump control function 1444 of the analysis control function 144.

The agitation unit 41 includes an agitation mechanism for agitating a mixture. The agitation of a mixture in the agitation unit 41 is performed by the analysis control function 144 in the processing circuitry 140 included in the control device 100, controlling the driving of the agitation mechanism using the agitation control function 1446.

The analyzing device 10 further includes the reagent bottle loading device 50, for example. The reagent bottle loading device 50 transfers the reagent bottles 16 between the first reagent storage 11, the second reagent storage 12, and a reagent replenishment storage (not illustrated) in which reagent bottles 16 for replenishment with reagent bottle adapters attached are placed. The reagent bottle loading device 50 includes, for example, a transfer arm 52 having a leading end portion 52a that grips a grip portion included in the opening/closing mechanism of the reagent bottle adapter to be described below. The transfer arm 52 is a pickup mechanism that removes reagent bottles 16 from the first reagent storage 11, the second reagent storage 12, and the reagent replenishment storage (not illustrated), and stores the removed reagents bottles 16 into the first reagent storage 11 or the second reagent storage 12. The reagent bottle loading device 50 can move the transfer arm 52 in three axial directions, and move (rotate) the transfer arm 52 about three axes. In other words, the reagent bottle loading device 50 can move the leading end portion 52a of the transfer arm 52 with six degrees of freedom. The number of degrees of freedom for the reagent bottle loading device 50 to move the leading end portion 52a of the transfer arm 52 does not have to be six, and may be fewer than six (e.g., four degrees of freedom) or more than six (e.g., eight degrees of freedom).

In accordance with the control from the analysis control function 144 in the processing circuitry 140 included in the control device 100 (control executed by the transfer control function 1448), the reagent bottle loading device 50 removes a designated reagent bottle 16 to be transferred, and performs transfer and storing. Furthermore, the reagent bottle loading device 50 changes the state of the opening/closing mechanism included in the reagent bottle 16, to the opened state or the closed state by moving a reagent bottle 16 stored in the first reagent storage 11 or the second reagent storage 12 one of the operation timings of a startup operation of starting up the analyzing device 10 to perform the analysis of a test sample, a preparation operation to be performed before analysis is started in the analyzing device 10, or a shutdown operation for stopping the analyzing device 10 after analysis is completed, for example. In other words, the reagent bottle loading device 50 performs opening and closing of the opening portion of the reagent bottle 16 by causing the leading end portion 52a of the transfer arm 52 to interfere with the reagent bottle 16.

The analyzing device 10 is an example of an “analyzing device”. The first reagent storage 11 and the second reagent storage 12 serve as an example of a “reagent bottle holding unit”. The reagent bottle loading device 50 (including the transfer arm 52 and the leading end portion 52a) is an example of a “transfer mechanism”. The first reagent dispensing probe 31 (may include the first reagent dispensing arm 21), and the second reagent dispensing probe 32 (may include the second reagent dispensing arm 22) serve as an example of a “reagent probe”.

### Structure and Opening/Closing Operation of Opening/Closing Mechanism of Reagent Bottle

Next, a structure of an opening/closing mechanism included in each reagent bottle 16, and its opening/closing operation will be described.

### First Embodiment

FIGS. 3A-1 to 3B-3 are diagrams illustrating an example of a structure and an opening/closing operation of an opening/closing mechanism of a reagent bottle according to the first embodiment. FIGS. 3A-1 to 3A-3 illustrate an example case where a general-purpose reagent bottle (hereinafter, referred to as a “general-purpose reagent bottle 160”) is provided with an opening/closing mechanism by attaching a reagent bottle adapter 200 having the opening/closing mechanism, thus forming a reagent bottle 16 having an opening/closing mechanism (hereinafter, referred to as an “opening/closing mechanism-equipped reagent bottle 16A”). FIGS. 3B-1 to 3B-3 illustrate an example case where a dedicated reagent bottle 16 having an integrated opening/closing mechanism (hereinafter referred to as “opening/closing mechanism-equipped reagent bottle 16B”) is used.

Initially, the reagent bottle adapter 200 illustrated in FIGS. 3A-1 to 3A-3 will be described. The reagent bottle adapter 200 includes, for example, a reagent bottle adapter main body portion 201 and a cap member portion 202. The reagent bottle adapter main body portion 201 and the cap member portion 202 are respectively provided with a communication hole 201h and a communication hole 202h that communicate with an opening portion 16p of the general-purpose reagent bottle 160 when the opening/closing mechanism is in the opened state, for example. The communication hole 201h also has a function of fixing the opening portion 16p of the general-purpose reagent bottle 160 at a predetermined position (i.e. the position of the communication hole 201h). The opening/closing mechanism of the reagent bottle adapter 200 is configured to change the state of the opening portion 16p of the general-purpose reagent bottle 160 to the opened state or the closed state by sliding the cap member portion 202 in a horizontal direction. For this reason, by causing the transfer arm 52 to interfere with the cap member portion 202 (more specifically, by sliding the cap member portion 202 in the horizontal direction using the transfer arm 52), the reagent bottle loading device 50 changes (shifts) the state of the opening portion 16p of the general-purpose reagent bottle 160 to the opened state or the closed state. The reagent bottle adapter main body portion 201 is provided with a grip portion 201a to be gripped by the leading end portion 52a of the transfer arm 52 of the reagent bottle loading device 50, for example, and the cap member portion 202 is provided with a grip portion 202a to be gripped by the leading end portion 52a of the transfer arm 52, for example.

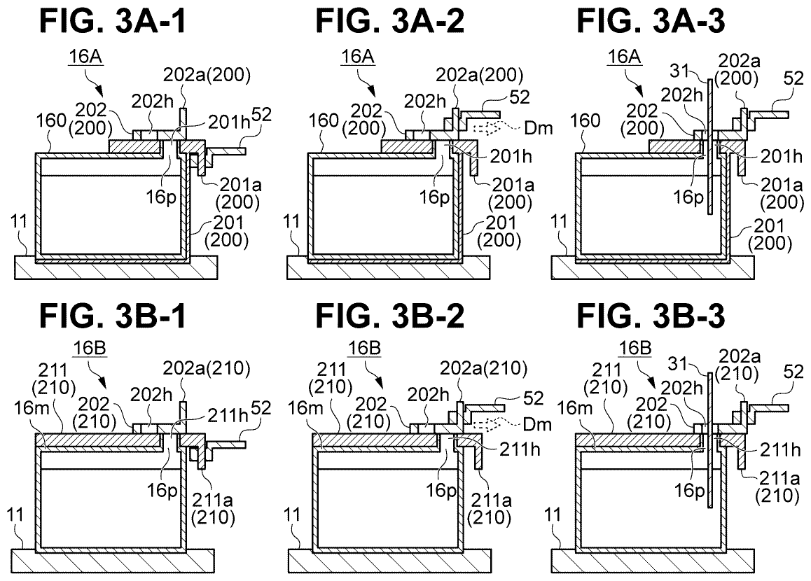

A predetermined state of the opening/closing mechanism of the reagent bottle adapter 200 (predetermined state) is a state in which the communication hole 201h and the communication hole 202h do not communicate with each other. That is, the predetermined state is a state in which the cap member portion 202 blocks the communication hole 201h of the reagent bottle adapter main body portion 201 and lids the general-purpose reagent bottle 160 in the opening/closing mechanism-equipped reagent bottle 16A. The reagent bottle loading device 50 causes the leading end portion 52a of the transfer arm 52 to grip the grip portion 201a of the opening/closing mechanism-equipped reagent bottle 16A in the predetermined state, and performs removal, transfer, and storing of the opening/closing mechanism-equipped reagent bottle 16A between the first reagent storage 11, the second reagent storage 12, and the reagent replenishment storage (not illustrated). FIG. 3A-1 illustrates a state in which the reagent bottle loading device 50 has gripped the grip portion 201a with the leading end portion 52a of the transfer arm 52, has transferred the opening/closing mechanism-equipped reagent bottle 16A, and has stored the opening/closing mechanism-equipped reagent bottle 16A into the first reagent storage 11.

Thereafter, for example, at the operation timing of a startup operation of starting up the analyzing device 10, or a preparation operation to be performed before the analysis is started in the analyzing device 10, the reagent bottle loading device 50 changes (shifts) the opening/closing mechanism-equipped reagent bottle 16A to the opened state, in other words, changes the opening portion 16p of the general-purpose reagent bottle 160 to the opened state, by sliding the cap member portion 202 in the horizontal direction using the transfer arm 52. FIG. 3A-2 illustrates a state in which the reagent bottle loading device 50 has caused the leading end portion 52a of the transfer arm 52 to grip the grip portion 202a of the opening/closing mechanism-equipped reagent bottle 16A stored in the first reagent storage 11, and has slid it in a moving direction Dm indicated by an arrow. Then, FIG. 3A-3 illustrates a state in which the cap member portion 202 has been slid in the horizontal direction up to a position where the communication hole 201h and the communication hole 202h are communicated with each other, in other words, a state in which the opening portion 16p of the general-purpose reagent bottle 160 is in the opened state. With this configuration, as illustrated in FIG. 3A-3, for example, the first reagent dispensing arm 21 can insert the first reagent dispensing probe 31 into the general-purpose reagent bottle 160 and aspirate the reagent stored in the general-purpose reagent bottle 160.

Thereafter, for example, at t an operation timing of a shutdown operation for stopping the analyzing device 10 after analysis is completed, the reagent bottle loading device 50 slides the cap member portion 202 in the horizontal direction opposite to the moving direction Dm indicated by the arrow in FIG. 3A-2, using the transfer arm 52, and changes (shifts) the state of the opening/closing mechanism-equipped reagent bottle 16A to the closed state in other words, changes the state of the opening portion 16p of the general-purpose reagent bottle 160 to the closed state).

Subsequently, an opening/closing mechanism of the opening/closing mechanism-equipped reagent bottle 16B illustrated in FIGS. 3B-1 to 3B-3 will be described. In the opening/closing mechanism-equipped reagent bottle 16B, for example, a reagent bottle main body portion 16m and an opening/closing mechanism (hereinafter, referred to as an “opening/closing mechanism 210”) are integrally formed. The opening/closing mechanism 210 includes, for example, an opening/closing mechanism main body portion 211 and the cap member portion 202. The opening/closing mechanism 210 has a configuration in which the reagent bottle adapter main body portion 201 constituting the reagent bottle adapter 200 is replaced with the opening/closing mechanism main body portion 211. As with the reagent bottle adapter main body portion 201, the opening/closing mechanism main body portion 211 is provided with a communication hole 211h through which the opening portion 16p of the reagent bottle main body portion 16m and the communication hole 202h are communicate when the opening/closing mechanism 210 is brought into the opened state, for example, and a grip portion 211a to be gripped by the leading end portion 52a of the transfer arm 52 of the reagent bottle loading device 50. As with the reagent bottle adapter 200, the opening/closing mechanism 210 is also configured to change the state of the opening portion 16p of the reagent bottle main body portion 16m to the opened state or the closed state by sliding the cap member portion 202 in the horizontal direction.

As with the reagent bottle adapter 200, the predetermined state of the opening/closing mechanism 210 is also a state in which the communication hole 211h and the communication hole 202h do not communicate with each other, in other words a state in which the cap member portion 202 blocks the communication hole 211h of the opening/closing mechanism main body portion 211 also in the opening/closing mechanism-equipped reagent bottle 16B. As with the case of the opening/closing mechanism-equipped reagent bottle 16A, the reagent bottle loading device 50 performs removal, transfer, and storing of the opening/closing mechanism-equipped reagent bottle 16B between the first reagent storage 11, the second reagent storage 12, and the reagent replenishment storage (not illustrated) using the transfer arm 52, and causes the transfer arm 52 to interfere with the cap member portion 202, thus changing (shifts) the state of the opening portion 16p of the reagent bottle main body portion 16m to the opened state or the closed state.

FIG. 3B-1 illustrates a state in which the reagent bottle loading device 50 has caused the leading end portion 52a of the transfer arm 52 to grip the grip portion 201a, transferred the opening/closing mechanism-equipped reagent bottle 16B, and has stored the opening/closing mechanism-equipped reagent bottle 16B into the first reagent storage 11, as with the case of the opening/closing mechanism-equipped reagent bottle 16A illustrated in FIG. 3A-1. FIG. 3B-2 illustrates a state in which, after the reagent bottle loading device 50 causes the leading end portion 52a of the transfer arm 52 to grip the grip portion 202a of the opening/closing mechanism-equipped reagent bottle 16A stored in the first reagent storage 11, the reagent bottle loading device 50 slides the transfer arm 52 in the moving direction Dm indicated by an arrow, as with the case of the opening/closing mechanism-equipped reagent bottle 16A illustrated in FIG. 3A-2. Then, FIG. 3B-3 illustrates a state in which the cap member portion 202 is slid in the horizontal direction up to a position where the communication hole 211h and the communication hole 202h are communicated with each other, in other words, a state in which the opening portion 16p of the reagent bottle main body portion 16m is in the opened state, as with the case of the opening/closing mechanism-equipped reagent bottle 16A illustrated in FIG. 3A-3. With this configuration, also in the opening/closing mechanism-equipped reagent bottle 16B, as illustrated in FIG. 3B-3, for example, the first reagent dispensing arm 21 can insert the first reagent dispensing probe 31 into the reagent bottle main body portion 16m and aspirate the reagent stored in the reagent bottle main body portion 16m. After that, the reagent bottle loading device 50 slides the cap member portion 202 in the horizontal direction opposite to the moving direction Dm indicated by the arrow in FIG. 3B-2, to change (shift) the state of the opening/closing mechanism-equipped reagent bottle 16B to the closed state.

FIGS. 3B-1 to 3B-3 illustrate the configuration of the opening/closing mechanism-equipped reagent bottle 16B in which the reagent bottle main body portion 16m and the opening/closing mechanism 210 are integrally formed. Alternatively, the configuration of the opening/closing mechanism 210 in the opening/closing mechanism-equipped reagent bottle 16B in other words, the configuration of the opening/closing mechanism main body portion 211 and the cap member portion 202, may be formed as a reagent bottle adapter, and the opening/closing mechanism-equipped reagent bottle 16B may be formed by attaching the reagent bottle adapter to the general-purpose reagent bottle 160.

As described above, the opening/closing mechanism according to the first embodiment is configured to change the state of the opening portion 16p of the reagent bottle 16 (the opening/closing mechanism-equipped reagent bottle 16A or the opening/closing mechanism-equipped reagent bottle 16B) to the opened state or the closed state by sliding the cap member portion 202 in the horizontal direction on the reagent bottle adapter main body portion 201 or the opening/closing mechanism main body portion 211. Then, in the opening/closing mechanism according to the first embodiment, by causing the transfer arm 52 to interfere with the cap member portion 202 in such a manner as to slide the cap member portion 202 in the horizontal direction on the reagent bottle adapter main body portion 201 or the opening/closing mechanism main body portion 211, the reagent bottle loading device 50 can change (shift) the state of the opening portion 16p of the reagent bottle 16 (the opening/closing mechanism-equipped reagent bottle 16A or the opening/closing mechanism-equipped reagent bottle 16B) to the opened state or the closed state. In other words, in the automated analyzer 1 that performs analysis (measurement) of a test sample in the analyzing device 10 using the reagent bottle 16 including the opening/closing mechanism according to the first embodiment, instead of starting the analysis (measurement) after the operator manually opens a cap of an opening portion of each reagent bottle to perform the analysis (measurement) of test samples as in the conventional automated analyzer, the reagent bottle loading device 50 can automatically change (shift) the state of the opening portions 16p of reagent bottles 16 to the opened state or the closed state at the time of any one operation timing of the startup operation, the preparation operation, and the shutdown operation of the analyzing device 10. With this configuration, in the automated analyzer 1 that performs analysis (measurement) of test samples in the analyzing device 10 using reagent bottles 16 each including the opening/closing mechanism according to the first embodiment, it is possible to prevent the cap of an opening portion of each reagent bottle from remaining constantly open during the analysis (measurement) of the test samples, unlike conventional automated analyzers. In other words, in the automated analyzer 1 that performs analysis (measurement) of test samples in the analyzing device 10 using reagent bottles 16 each including the opening/closing mechanism according to the first embodiment, it is possible to reduce factors that may accelerate degradation of reagent quality, such as evaporation of the reagents contained in the reagent bottles 16 during the analysis (measurement) of the sample, which may lead to concentration of the reagent or contamination by other reagents carried through the air.

In the automated analyzer 1 that performs analysis (measurement) of test samples in the analyzing device 10 using reagent bottles 16 each including the opening/closing mechanism according to the first embodiment, the reagent bottle loading device 50 can automatically change (shift) the state of the opening portions 16p of the reagent bottles 16 to the opened state or the closed state. Thus, it is possible to set a timing of changing (shifting) the state of the opening portion 16p of the reagent bottle 16 to the opened state or the closed state, in accordance with the characteristics of a reagent, in other words, in accordance with each reagent. For example, a reagent bottle 16 that contains a reagent with low usage frequency or a reagent highly susceptible to evaporation or contamination can have its opening portion 16p set to the opened state immediately before use (e.g., just before inserting the first reagent dispensing probe 31 into the general-purpose reagent bottle 160) and returned to the closed state immediately after use (e.g., just after withdrawing the first reagent dispensing probe 31 that has been inserted into the general-purpose reagent bottle 160). In this way, the timing for switching the opening portion 16p of the reagent bottle 16 between the opened state and the closed state can be set for each reagent. Accordingly, in the automated analyzer 1 that performs analysis (measurement) of a test sample using the reagent bottle 16 including the opening/closing mechanism according to the first embodiment in the analyzing device 10, the opening portion 16p of the reagent bottle 16 can be switched to the opened state immediately before the reagent contained in the reagent bottle 16 is aspirated (dispensed) by the first reagent dispensing probe 31 or the second reagent dispensing probe 32, and switched back to the closed state immediately after aspiration (dispensing) of the reagent contained in the reagent bottle 16. The timing for switching the opening portion 16p of a reagent bottle 16 between the open state and the closed state may be set by the operator while the automated analyzer 1 is performing analysis of a test sample, or may be automatically set by, for example, the analysis control function 144 based on the characteristics of the reagent identified from reagent identification information (reagent ID).

In the above-described opening/closing mechanism according to the first embodiment, the configuration of changing the state of the opening portion 16p of the reagent bottle 16 (the opening/closing mechanism-equipped reagent bottle 16A or the opening/closing mechanism-equipped reagent bottle 16B) to the opened state or the closed state by sliding the cap member portion 202 in the horizontal direction on the reagent bottle adapter main body portion 201 or the opening/closing mechanism main body portion 211 has been described. The configuration of changing the state of the opening portion 16p of the reagent bottle 16 to the opened state or the closed state is not limited to the configuration of sliding the cap member portion 202 in the horizontal direction. For example, the cap member portion 202 may be rotated in the horizontal direction (rotating the cap member portion 202 about an axis extending in a vertical direction) on the reagent bottle adapter main body portion 201 or the opening/closing mechanism main body portion 211 to change the state of the opening portion 16p of the reagent bottle 16 (the opening/closing mechanism-equipped reagent bottle 16A or the opening/closing mechanism-equipped reagent bottle 16B) to the opened state or the closed state.

The reagent bottle adapter 200 is an example of an “opening/closing mechanism” and a “reagent bottle adapter”. The opening/closing mechanism 210 is an example of an “opening/closing mechanism”. The opening/closing mechanism-equipped reagent bottle 16A and the opening/closing mechanism-equipped reagent bottle 16B serve as an example of a “reagent bottle including an opening/closing mechanism”. The grip portion 202a is an example of “part of an opening/closing mechanism with which a transfer mechanism interferes”.

### Second Embodiment

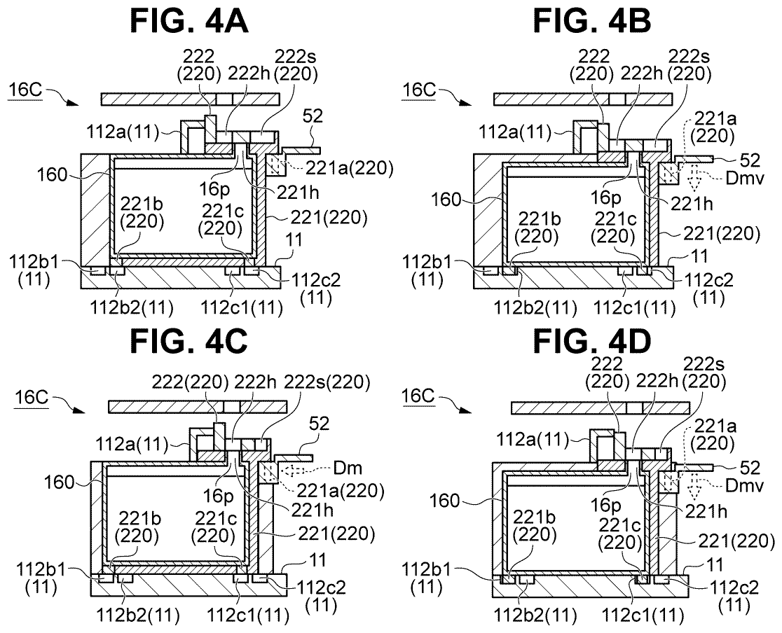

FIGS. 4A to 4D are diagrams illustrating an example of a structure and an opening/closing operation of an opening/closing mechanism of a reagent bottle according to the second embodiment. FIGS. 4A to 4D illustrate an example case where a reagent bottle 16 including an opening/closing mechanism (hereinafter, referred to as an “opening/closing mechanism-equipped reagent bottle 16C”) is formed by attaching a reagent bottle adapter 220 including an opening/closing mechanism, to the general-purpose reagent bottle 160.

The reagent bottle adapter 220 includes, for example, a reagent bottle adapter main body portion 221 and a cap member portion 222. The reagent bottle adapter main body portion 221 and the cap member portion 222 are respectively provided with a communication hole 221h and a communication hole 222h that communicate with the opening portion 16p of the general-purpose reagent bottle 160 when the state of the opening/closing mechanism is in the opened state, for example. The communication hole 221h also has a function of fixing the opening portion 16p of the general-purpose reagent bottle 160 to a predetermined position (i.e. the position of the communication hole 221h). An opening/closing mechanism of the reagent bottle adapter 220 is configured to moves the entire opening/closing mechanism-equipped reagent bottle 16C in the horizontal direction to slide the cap member portion 222 in the horizontal direction, thus changing the state of the opening portion 16p of the general-purpose reagent bottle 160 to the opened state or the closed state. Thus, the reagent bottle loading device 50 causes the transfer arm 52 to move the opening/closing mechanism-equipped reagent bottle 16C to an opened state position to change (shift) the state of the opening portion 16p of the general-purpose reagent bottle 160 to the opened state. The reagent bottle loading device 50 moves the opening/closing mechanism-equipped reagent bottle 16C to a closed state position to change (shift) the state of the opening portion 16p of the general-purpose reagent bottle 160 to the closed state. The reagent bottle adapter main body portion 221 is provided with a grip portion 221a to be gripped by the leading end portion 52a of the transfer arm 52 of the reagent bottle loading device 50, for example. The cap member portion 222 includes, for example, a spring portion 222s that extends in a predetermined state and at a closed state position so that the opening/closing mechanism-equipped reagent bottle 16C is in the closed state, and in a case where the opening/closing mechanism-equipped reagent bottle 16C is moved to the opened state position, contracts so that the opening/closing mechanism-equipped reagent bottle 16C is in the opened state. Then, the first reagent storage 11 and the second reagent storage 12 are each provided with, for example, a contact portion that comes into contact with the cap member portion 222 including the reagent bottle adapter 220, and interferes with the cap member portion 222 in accordance with the movement of the opening/closing mechanism-equipped reagent bottle 16C. FIGS. 4D and 4C illustrate a configuration in which a contact portion 112a that interferes with the cap member portion 222 is provided in the first reagent storage 11. When the opening/closing mechanism-equipped reagent bottle 16C is moved to the closed state position, the contact portion 112a does not interfere with the cap member portion 222, and when the opening/closing mechanism-equipped reagent bottle 16C is moved to the opened state position, the contact portion 112a interferes with the cap member portion 222 to slide the cap member portion 222 in the horizontal direction. Furthermore, the reagent bottle adapter main body portion 221 is provided with a protrusion-shaped guide portion for holding a position to which the opening/closing mechanism-equipped reagent bottle 16C is moved, in a case where the opening/closing mechanism-equipped reagent bottle 16C is moved to the opened state position or the closed state position, for example. FIGS. 4D and 4C illustrate a configuration in which the reagent bottle adapter main body portion 221 is provided with two guide portions corresponding to a guide portion 221b and a guide portion 221c to hold the position to which the opening/closing mechanism-equipped reagent bottle 16C has been moved, at two points. The number of guide portions provided in the reagent bottle adapter main body portion 221 may be two or more. In contrast, the first reagent storage 11 and the second reagent storage 12 are each provided with a recess-shaped guide reception portion that engages with a guide portion provided in the reagent bottle adapter main body portion 221, for example. FIGS. 4D and 4C illustrate a configuration in which guide reception portions 112b1 and 112c1 that respectively engage with the guide portions 221b and 221c of the reagent bottle adapter main body portion 221 at the opened state position are provided, and guide reception portions 112b2 and 112c2 that respectively engage with the guide portions 221b and 221c of the reagent bottle adapter main body portion 221 at the closed state position are provided in the first reagent storage 11. The number of guide reception portions provided in each of the first reagent storage 11 and the second reagent storage 12 is only required to be a number corresponding to the number of guide portions provided in the reagent bottle adapter main body portion 221.

As with the predetermined state of the reagent bottle adapter 200 and the opening/closing mechanism 210, the predetermined state in the opening/closing mechanism of the reagent bottle adapter 220 is also a state in which the communication hole 221h and the communication hole 222h do not communicate with each other, in other words, a state in which the cap member portion 222 blocks the communication hole 221h of the reagent bottle adapter main body portion 221 and lids the general-purpose reagent bottle 160 also in the opening/closing mechanism-equipped reagent bottle 16C). By causing the leading end portion 52a of the transfer arm 52 to grip the grip portion 221a of the opening/closing mechanism-equipped reagent bottle 16C in the predetermined state, the reagent bottle loading device 50 performs removal, transfer, and storing of the opening/closing mechanism-equipped reagent bottle 16C between the first reagent storage 11, the second reagent storage 12, and the reagent replenishment storage (not illustrated). FIG. 4A illustrates a state in which the reagent bottle loading device 50 has caused the leading end portion 52a of the transfer arm 52 to grip the grip portion 221a, and has transferred the opening/closing mechanism-equipped reagent bottle 16C to the first reagent storage 11.

After that, the reagent bottle loading device 50 moves the opening/closing mechanism-equipped reagent bottle 16C in the vertical direction using the transfer arm 52, stores the opening/closing mechanism-equipped reagent bottle 16C at the closed state position, changes (shifts) the state of the opening/closing mechanism-equipped reagent bottle 16C to the closed state, in other words, changes to the state of the opening portion 16p of the general-purpose reagent bottle 160 to the closed state, and holds the state. FIG. 4B illustrates a state in which, by moving the opening/closing mechanism-equipped reagent bottle 16C in a vertical moving direction DmV indicated by an arrow, the guide portion 221b and the guide reception portion 112b2 of the first reagent storage 11 have engaged with each other, and the guide portion 221c and the guide reception portion 112c2 of the first reagent storage 11 have engaged with each other, whereby the opening/closing mechanism-equipped reagent bottle 16C is held in the closed state inside the first reagent storage 11.

After that, for example, at the time of an operation timing of the startup operation or the preparation operation of the analyzing device 10, the reagent bottle loading device 50 causes the transfer arm 52 to move the entire opening/closing mechanism-equipped reagent bottle 16C in the horizontal direction, thus sliding the cap member portion 222 in the horizontal direction to change (shift) the state of the opening/closing mechanism-equipped reagent bottle 16C to the opened state, that is, to change (shift) the state of the opening portion 16p of the general-purpose reagent bottle 160 to the opened state. At this time, the reagent bottle loading device 50 initially cancels a held state in which the opening/closing mechanism-equipped reagent bottle 16C is held in the closed state. More specifically, the reagent bottle loading device 50 causes the transfer arm 52 to move the opening/closing mechanism-equipped reagent bottle 16C in a vertical direction opposite to the vertical moving direction DmV indicated by the arrow in FIG. 4B, thus releasing the closed state of the opening/closing mechanism-equipped reagent bottle 16C. Nevertheless, even in this state, the default state of the opening/closing mechanism of the reagent bottle adapter 220 is the closed state so that the opening/closing mechanism-equipped reagent bottle 16C remains in the closed state. Thus, the state of the opening/closing mechanism-equipped reagent bottle 16C at this time is in the same state as the state illustrated in FIG. 4A.

Then, the reagent bottle loading device 50 causes the transfer arm 52 to move the entire opening/closing mechanism-equipped reagent bottle 16C in the horizontal direction, thus sliding the cap member portion 222 in the horizontal direction to change (shift) the state of the opening/closing mechanism-equipped reagent bottle 16A to the opened state. FIG. 4C illustrates a state in which, by moving the entire opening/closing mechanism-equipped reagent bottle 16C in a horizontal moving direction DmH indicated by an arrow, the reagent bottle loading device 50 has changed (shifted) the state of the opening/closing mechanism-equipped reagent bottle 16A to the opened state. At this time, as illustrated in FIG. 4C, in the reagent bottle adapter 220, the spring portion 222s has been pushed in and has become compressed due to interference of the contact portion 112a with the cap member portion 222.

After that, by moving the opening/closing mechanism-equipped reagent bottle 16C in the vertical direction with the transfer arm 52, the reagent bottle loading device 50 stores the opening/closing mechanism-equipped reagent bottle 16C at the opened state position, and holds the opening/closing mechanism-equipped reagent bottle 16C in the opened state. FIG. 4D illustrates a state in which, by moving the opening/closing mechanism-equipped reagent bottle 16C in the vertical moving direction DmV indicated by an arrow, the guide portion 221b and the guide reception portion 112b1 of the first reagent storage 11 have engaged with each other, and the guide portion 221c and the guide reception portion 112c1 of the first reagent storage 11 have engaged with each other, whereby the opening/closing mechanism-equipped reagent bottle 16C is held in the opened state in the first reagent storage 11. With this configuration, for example, the first reagent dispensing arm 21 can aspirate the reagent stored in the general-purpose reagent bottle 160, by inserting the first reagent dispensing probe 31 into the general-purpose reagent bottle 160.

After that, for example, at an operation timing of the shutdown operation of the analyzing device 10, the reagent bottle loading device 50 changes (shifts) the state of the opening/closing mechanism-equipped reagent bottle 16C to the closed state (refer to FIG. 4B) by sliding the cap member portion 202 by the transfer arm 52 in the horizontal direction opposite to the horizontal moving direction DmH indicated by the arrow in FIGS. 4D and 4C.

As described above, the opening/closing mechanism according to the second embodiment is configured to change the state of the opening portion 16p of the opening/closing mechanism-equipped reagent bottle 16C to the opened state or the closed state by moving, in the horizontal direction, the entire opening/closing mechanism-equipped reagent bottle 16C to which the reagent bottle adapter main body portion 221 is attached to slide the cap member portion 222 in the horizontal direction. Then, in the opening/closing mechanism according to the second embodiment, the reagent bottle loading device 50 can change (shift) the state of the opening portion 16p of the opening/closing mechanism-equipped reagent bottle 16C to the opened state or the closed state by moving the entire opening/closing mechanism-equipped reagent bottle 16C in the horizontal direction to cause the contact portion 112a, which interferes with the cap member portion 222, to slide the cap member portion 222 in the horizontal direction. In other words, also in the automated analyzer 1 that performs analysis (measurement) of a test sample in the analyzing device 10 using the reagent bottle 16 including the opening/closing mechanism according to the second embodiment, as with the automated analyzer 1 that performs analysis (measurement) of a test sample in the analyzing device 10 using the reagent bottle 16 including the opening/closing mechanism according to the first embodiment, at any one operation timing of the startup operation, the preparation operation, and the shutdown operation of the analyzing device 10, the reagent bottle loading device 50 can automatically change (shift) the state of the opening portion 16p of the reagent bottle 16 to the opened state or the closed state. With this configuration, also in the automated analyzer 1 that performs analysis (measurement) of a test sample in the analyzing device 10 using the reagent bottle 16 including the opening/closing mechanism according to the second embodiment, as with the automated analyzer 1 that performs analysis (measurement) of a test sample in the analyzing device 10 using the reagent bottle 16 including the opening/closing mechanism according to the first embodiment, it is possible to reduce factors that may accelerate degradation of reagent quality during the analysis (measurement) of a test sample.

Moreover, in the opening/closing mechanism according to the second embodiment, unlike the opening/closing mechanism according to the first embodiment, when the state of the opening portion 16p of the opening/closing mechanism-equipped reagent bottle 16C is changed (shifted) to the opened state or the closed state, the number of grip portions of the opening/closing mechanism-equipped reagent bottle 16C that the reagent bottle loading device 50 causes the leading end portion 52a of the transfer arm 52 to grip is only one (the grip portion 221a). For this reason, in the automated analyzer 1 that performs analysis (measurement) of a test sample in the analyzing device 10 using the reagent bottle 16 including the opening/closing mechanism according to the second embodiment, the control of the reagent bottle loading device 50 that is performed when the state of the opening portion 16p of the opening/closing mechanism-equipped reagent bottle 16C is changed (shifted) to the opened state or the closed state can be made simpler than the control performed by the automated analyzer 1 that performs analysis (measurement) of a test sample in the analyzing device 10 using the reagent bottle 16 including the opening/closing mechanism according to the first embodiment.

Further, in the automated analyzer 1 that performs analysis (measurement) of a test sample in the analyzing device 10 using the reagent bottle 16 including the opening/closing mechanism according to the second embodiment, the reagent bottle loading device 50 can automatically change (shift) the state of the opening portion 16p of the reagent bottle 16 to the opened state or the closed state. Thus, as with the automated analyzer 1 that performs analysis (measurement) of a test sample in the analyzing device 10 using the reagent bottle 16 including the opening/closing mechanism according to the first embodiment, it is possible to set the timing for changing (shifting) the state of the opening portion 16p of the reagent bottle 16 to the opened state or the closed state, for each reagent.

In the above-described opening/closing mechanism according to the second embodiment, a description has been provided of the configuration of changing the state of the opening portion 16p of the opening/closing mechanism-equipped reagent bottle 16C to the opened state or the closed state by moving the entire opening/closing mechanism-equipped reagent bottle 16C in the horizontal direction to slide the cap member portion 222 in the horizontal direction. However, also in the opening/closing mechanism according to the second embodiment, as with the opening/closing mechanism according to the first embodiment, the configuration of changing the state of the opening portion 16p of the reagent bottle 16 to the opened state or the closed state is not limited to the configuration realized by sliding the cap member portion 222 in the horizontal direction. For example, the configuration may be such that the state of the opening portion 16p of the opening/closing mechanism-equipped reagent bottle 16C to the opened state or the closed state by rotating the cap member portion 222 in the horizontal direction through rotation of the entire opening/closing mechanism-equipped reagent bottle 16C to which the reagent bottle adapter 220 is attached.

In the above-described opening/closing mechanism according to the second embodiment, a configuration has been described in which the reagent bottle adapter 220 is attached to the general-purpose reagent bottle 160 to form the reagent bottle 16 including an opening/closing mechanism (the opening/closing mechanism-equipped reagent bottle 16C). However, as with the opening/closing mechanism according to the first embodiment, the dedicated reagent bottle 16 integrated with an opening/closing mechanism may be employed. In this case, the configuration can be realized by integrating an opening/closing mechanism having a structure similar to that of the reagent bottle adapter 220 with the main body of the reagent bottle, adopting an idea similar to the opening/closing mechanism according to the first embodiment. Thus, a detailed description of an example of the configuration of a dedicated reagent bottle 16 in which an opening/closing mechanism having a structure similar to that of the reagent bottle adapter 220 is integrated will be omitted.

The reagent bottle adapter 220 is an example of an “opening/closing mechanism” and a “reagent bottle adapter”. The opening/closing mechanism-equipped reagent bottle 16C is an example of a “reagent bottle including an opening/closing mechanism”. The contact portion 112a is an example of an “interference unit which interferes with a part of an opening/closing mechanism”.

### Third Embodiment

FIGS. 5A-1 to 5C are diagrams illustrating an example of a structure and an opening/closing operation of an opening/closing mechanism of a reagent bottle according to a third embodiment. FIGS. 5A-1 to 5C illustrate an example in which a reagent bottle adapter 230 including an opening/closing mechanism is attached to the general-purpose reagent bottle 160, thus forming a reagent bottle 16 including an opening/closing mechanism (hereinafter, referred to as an “opening/closing mechanism-equipped reagent bottle 16D”).

The reagent bottle adapter 230 includes, for example, a reagent bottle adapter main body portion 231 and a cap member portion 232. The reagent bottle adapter main body portion 231 and the cap member portion 232 are respectively provided with a communication hole 231h and a communication hole 232h that communicate with the opening portion 16p of the general-purpose reagent bottle 160 when an opening/closing mechanism is in the opened state, for example. The communication hole 231h also has a function of fixing the opening portion 16p of the general-purpose reagent bottle 160 at a predetermined position (i.e. the position of the communication hole 231h). As with the opening/closing mechanism of the reagent bottle adapter 220, the opening/closing mechanism of the reagent bottle adapter 230 is also configured to change the state of the opening portion 16p of the general-purpose reagent bottle 160 to the opened state or the closed state by moving the entire opening/closing mechanism-equipped reagent bottle 16D in the horizontal direction to slide the cap member portion 232 in the horizontal direction. For this reason, also in the opening/closing mechanism of the reagent bottle adapter 230, the reagent bottle loading device 50 changes (shifts) the state of the opening portion 16p of the general-purpose reagent bottle 160 to the opened state by moving the opening/closing mechanism-equipped reagent bottle 16D to the opened state position with the transfer arm 52, and changes (shifts) the state of the opening portion 16p of the general-purpose reagent bottle 160 to the closed state by moving the opening/closing mechanism-equipped reagent bottle 16D to the closed state position. The reagent bottle adapter main body portion 231 is provided with a grip portion 231a to be gripped by the leading end portion 52a of the transfer arm 52 of the reagent bottle loading device 50, for example. Then, the first reagent storage 11 and the second reagent storage 12 are each provided with a contact portion that comes into contact with the cap member portion 232 included in the reagent bottle adapter 230, for example, and interferes with the cap member portion 232 in accordance with the movement of the opening/closing mechanism-equipped reagent bottle 16D. FIGS. 5A-1 to 5C illustrate a configuration in which a contact portion 113a that interferes with the cap member portion 232 is provided in the first reagent storage 11. As with the contact portion 112a that slides the cap member portion 222 included in the reagent bottle adapter 220, the contact portion 113a does not interfere with the cap member portion 232 when moving the opening/closing mechanism-equipped reagent bottle 16D to the closed state position, but interferes with the cap member portion 232 and slides the cap member portion 232 in the horizontal direction when moving the opening/closing mechanism-equipped reagent bottle 16D to the opened state position. Then, in the opening/closing mechanism of the reagent bottle adapter 230, in place of the guide portion included in the reagent bottle adapter 220, a protrusion-shaped insertion portion for holding a position to which the opening/closing mechanism-equipped reagent bottle 16D is moved, in a case where the opening/closing mechanism-equipped reagent bottle 16D is moved to the opened state position or the closed state position, for example. FIGS. 5A-1 to 5C illustrate a configuration in which an insertion portion 231b for holding the position to which the opening/closing mechanism-equipped reagent bottle 16D has been moved is provided in the reagent bottle adapter main body portion 231 at a lower end of the side surface of the reagent bottle adapter main body portion 231. The shape of the insertion portion 231b may be a shape in which a protrusion shape is continuously formed at the lower end of the side surface of the reagent bottle adapter main body portion 231, or a shape in which protrusion shapes like cylindrical projections are separately formed at a plurality of points at the lower end of the side surface of the reagent bottle adapter main body portion 231, for example. On the other hand, the first reagent storage 11 and the second reagent storage 12 are each provided with a recess-shaped groove portion that engages with the insertion portion 231b provided in the reagent bottle adapter main body portion 231, for example, in place of the guide reception portion that engages with the guide portion provided in the reagent bottle adapter 220. FIGS. 5A-1 to 5C illustrate a configuration in which, in the first reagent storage 11, a groove portion 113b that engages with the insertion portion 231b of the reagent bottle adapter main body portion 231 in a case where the opening/closing mechanism-equipped reagent bottle 16D is placed at the opened state position is provided, and a groove portion 113c that engages with the insertion portion 231b of the reagent bottle adapter main body portion 231 in a case where the opening/closing mechanism-equipped reagent bottle 16D is placed at the closed state position is provided. The groove portion 113b and the groove portion 113c each have a shape in which a groove is formed along a side of a trapezoid that is other than a bottom surface, for example. Then, the groove portion 113b and the groove portion 113c are provided with being shifted in the vertical direction (up-down direction) and the horizontal direction (left-right direction) illustrated in FIGS. 5A-1 to 5C.

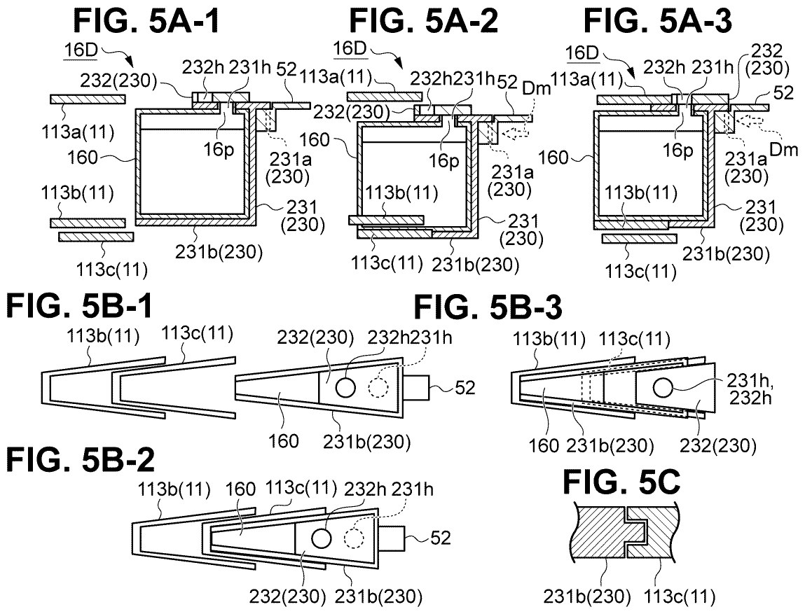

As with the predetermined state of the reagent bottle adapter 220 or the like, a predetermined state in the opening/closing mechanism of the reagent bottle adapter 230 is also a state in which the communication hole 231h and the communication hole 232h do not communicate with each other, in other words, a state in which the cap member portion 232 blocks the communication hole 231h of the reagent bottle adapter main body portion 231 and lids the general-purpose reagent bottle 160 also in the opening/closing mechanism-equipped reagent bottle 16D). By causing the leading end portion 52a of the transfer arm 52 to grip the grip portion 231a of the opening/closing mechanism-equipped reagent bottle 16D in this predetermined state, the reagent bottle loading device 50 performs removal, transfer, and storing of the opening/closing mechanism-equipped reagent bottle 16D between the first reagent storage 11, the second reagent storage 12, and the reagent replenishment storage (not illustrated). FIG. 5A-1 illustrates a state in which the reagent bottle loading device 50 causes the leading end portion 52a of the transfer arm 52 to grip the grip portion 231a, and transfers the opening/closing mechanism-equipped reagent bottle 16D to the first reagent storage 11. Furthermore, FIG. 5B-1 illustrates a positional relationship between the opening/closing mechanism-equipped reagent bottle 16D, the groove portion 113b, and the groove portion 113c that is obtainable when the state illustrated in FIG. 5A-1 is viewed from the upper side (side from which the first reagent dispensing probe 31 is inserted). In FIG. 5B-1, the illustration of the grip portion 231a and the contact portion 113a is omitted.

After that, by moving the entire opening/closing mechanism-equipped reagent bottle 16D in the horizontal direction using the transfer arm 52, at a height at which the insertion portion 231b fits into the groove portion 113c, the reagent bottle loading device 50 stores the opening/closing mechanism-equipped reagent bottle 16D at the closed state position, changes (shifts) the state of the opening/closing mechanism-equipped reagent bottle 16D to the closed state, that is, changes (shifts) the state of the opening portion 16p of the general-purpose reagent bottle 160 to the closed state, and holds the state. FIG. 5A-2 illustrates a state in which the opening/closing mechanism-equipped reagent bottle 16D is held in a closed state within the first reagent storage 11. This state is achieved by the reagent bottle loading device 50 moving the opening/closing mechanism-equipped reagent bottle 16D in a moving direction Dm indicated by an arrow, at a height where the insertion portion 231b fits into the groove portion 113c so that the protrusion shape of the insertion portion 231b fits into a recess-shaped groove of the groove portion 113c. Furthermore, FIG. 5B-2 illustrates a positional relationship between the opening/closing mechanism-equipped reagent bottle 16D, the groove portion 113b, and the groove portion 113c when the state illustrated in FIG. 5A-2 is viewed from the upper side. In FIG. 5B-2, the illustration of the grip portion 231a and the contact portion 113a is omitted. Furthermore, FIG. 5C illustrates an example of a state in which the insertion portion 231b fits into the groove portion 113c.

After that, for example, at the time of an operation timing of the startup operation or the preparation operation of the analyzing device 10, the reagent bottle loading device 50 releases the closed state of the opening/closing mechanism-equipped reagent bottle 16D by moving the opening/closing mechanism-equipped reagent bottle 16D with the transfer arm 52 in the horizontal direction opposite to the moving direction Dm as indicated by the arrow in FIG. 5A-2. In this case, the predetermined state of the opening/closing mechanism of the reagent bottle adapter 230 is the closed state, so that the opening/closing mechanism-equipped reagent bottle 16D remains in the closed state. Thus, the state of the opening/closing mechanism-equipped reagent bottle 16D at this time is the same state as the state illustrated in FIGS. 5A-1 and 5B-1. Then, by moving the entire opening/closing mechanism-equipped reagent bottle 16D in the horizontal direction with the transfer arm 52 at a height at which the insertion portion 231b fits into the groove portion 113b, the reagent bottle loading device 50 slides the cap member portion 232 in the horizontal direction, changes (shifts) the state of the opening/closing mechanism-equipped reagent bottle 16D to the opened state, in other words, changes (shifts) the state of the opening portion 16p of the general-purpose reagent bottle 160 to the opened state, and holds the state. FIG. 5A-3 illustrates a state in which the opening/closing mechanism-equipped reagent bottle 16D is held in the opened state in the first reagent storage 11. This state is achieved by the reagent bottle loading device 50 moving the opening/closing mechanism-equipped reagent bottle 16D in the moving direction Dm indicated by the arrow, at a height at which the insertion portion 231b fits into the groove portion 113b so that the protrusion shape of the insertion portion 231b fits into the recess-shaped groove of the groove portion 113b, and the cap member portion 232 is further slid due to the interference of the contact portion 113a with the cap member portion 232. Furthermore, FIG. 5B-3 illustrates a positional relationship between the opening/closing mechanism-equipped reagent bottle 16D, the groove portion 113b, and the groove portion 113c when the state illustrated in FIG. 5A-3 is viewed from the upper side. In FIG. 5B-3, the illustration of the grip portion 231a and the contact portion 113a is omitted. Also in this case, an example of a state in which the insertion portion 231b fits into the groove portion 113b is a state in which the groove portion 113c illustrated in FIG. 5C is replaced with the groove portion 113b. With this configuration, for example, the first reagent dispensing arm 21 can aspirate the reagent stored in the general-purpose reagent bottle 160, by inserting the first reagent dispensing probe 31 into the general-purpose reagent bottle 160.

After that, for example, at the time of an operation timing of the shutdown operation of the analyzing device 10, the reagent bottle loading device 50 changes (shifts) the state of the opening/closing mechanism-equipped reagent bottle 16D with the transfer arm 52 to the closed state as illustrated in FIGS. 5A-2 and 5B-2.

As described above, the opening/closing mechanism according to the third embodiment is configured to change the state of the opening portion 16p of the opening/closing mechanism-equipped reagent bottle 16D to the opened state or the closed state by moving, in the horizontal direction, the entire opening/closing mechanism-equipped reagent bottle 16D to which the reagent bottle adapter main body portion 231 is attached, at a height varying between the opened state position and the closed state position to slide the cap member portion 232 in the horizontal direction. Additionally, in the opening/closing mechanism according to the third embodiment, the reagent bottle loading device 50 can change (shift) the state of the opening portion 16p of the opening/closing mechanism-equipped reagent bottle 16D to the opened state or the closed state by moving the entire opening/closing mechanism-equipped reagent bottle 16D in the horizontal direction at the height of the opened state position or the closed state position so that the contact portion 113a, which interferes with the cap member portion 232, slides the cap member portion 232 in the horizontal direction. In other words, also in the automated analyzer 1 that performs analysis (measurement) of a test sample in the analyzing device 10 using the reagent bottle 16 including the opening/closing mechanism according to the third embodiment, as with the automated analyzer 1 that performs analysis (measurement) of a test sample in the analyzing device 10 using the reagent bottle 16 including the opening/closing mechanism according to the first and second embodiments, the reagent bottle loading device 50 can automatically change (shift) the state of the opening portion 16p of the reagent bottle 16 to the opened state or the closed state at the time of a required operation timing in the analyzing device 10. With this configuration, also in the automated analyzer 1 that performs analysis (measurement) of a test sample in the analyzing device 10 using the reagent bottle 16 including the opening/closing mechanism according to the third embodiment, as with the automated analyzer 1 that performs analysis (measurement) of a test sample in the analyzing device 10 using the reagent bottle 16 including the opening/closing mechanism according to the first and second embodiments, it is possible to reduce factors that may accelerate degradation of reagent quality during the analysis (measurement) of a test sample.

Moreover, also in the opening/closing mechanism according to the third embodiment, as with the opening/closing mechanism according to the second embodiment, when changing (shifting) the state of the opening portion 16p of the opening/closing mechanism-equipped reagent bottle 16D to the opened state or the closed state, the number of grip portions of the opening/closing mechanism-equipped reagent bottle 16D that the reagent bottle loading device 50 causes the leading end portion 52a of the transfer arm 52 to grip is only one (the grip portion 231a). This can simplify the control of the reagent bottle loading device 50. Moreover, also in the automated analyzer 1 that performs analysis (measurement) of a test sample in the analyzing device 10 using the reagent bottle 16 including the opening/closing mechanism according to the third embodiment, as with the automated analyzer 1 that performs analysis (measurement) of a test sample in the analyzing device 10 using the reagent bottle 16 including the opening/closing mechanism according to the first and second embodiments, it is possible to set a timing of changing (shifting) the state of the opening portion 16p of the reagent bottle 16 to the opened state or the closed state, for each reagent.

In the opening/closing mechanism according to the above-described third embodiment, a configuration in a case where the reagent bottle 16 including the opening/closing mechanism (the opening/closing mechanism-equipped reagent bottle 16D) is formed by attaching the reagent bottle adapter 230 to the general-purpose reagent bottle 160 has been described, but the dedicated reagent bottle 16 integrated with an opening/closing mechanism may be employed, as with the opening/closing mechanism according to the first and second embodiments. In this case, the configuration can be realized by integrating an opening/closing mechanism having a structure similar to that of the reagent bottle adapter 230 with the main body of the reagent bottle, adopting an idea similar to the opening/closing mechanism according to the first embodiment, for example. Thus, the detailed description of an example of a configuration of the dedicated reagent bottle 16 integrated with an opening/closing mechanism with a structure similar to that of the reagent bottle adapter 230 will be omitted.

The reagent bottle adapter 230 is an example of an “opening/closing mechanism” and a “reagent bottle adapter”. The opening/closing mechanism-equipped reagent bottle 16D is an example of a “reagent bottle including an opening/closing mechanism”. The contact portion 113a is an example of an “interference unit that interferes with a part of an opening/closing mechanism”.

### Fourth Embodiment

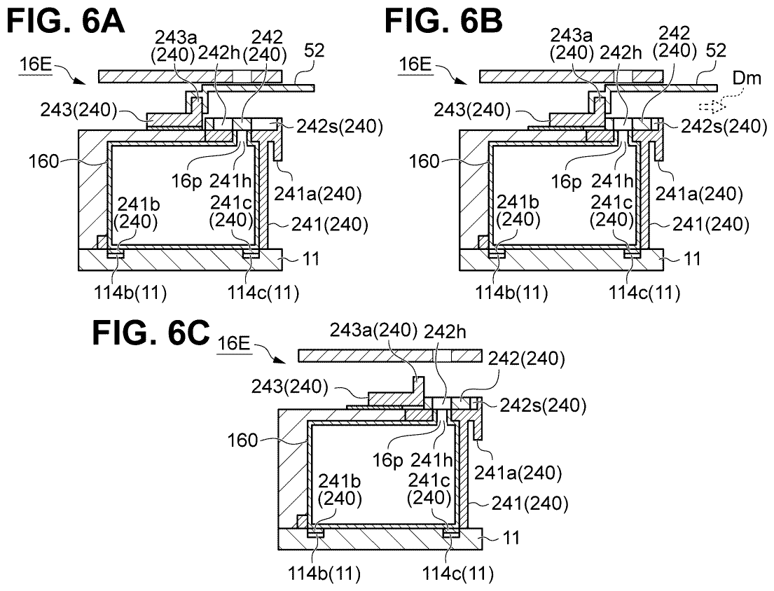

FIGS. 6A to 6C are diagrams schematically illustrating an example of a structure and an opening/closing operation of an opening/closing mechanism of a reagent bottle according to the fourth embodiment. FIGS. 6A to 6C illustrate an example case where a reagent bottle 16 including an opening/closing mechanism (hereinafter, referred to as an “opening/closing mechanism-equipped reagent bottle 16E”) is formed by attaching a reagent bottle adapter 240 including an opening/closing mechanism, to the general-purpose reagent bottle 160.

The reagent bottle adapter 240 includes, for example, a reagent bottle adapter main body portion 241, a cap member portion 242, and an opening/closing portion 243. The reagent bottle adapter main body portion 241 and the cap member portion 242 are each provided with a communication hole 241h and a communication hole 242h that communicate with the opening portion 16p of the general-purpose reagent bottle 160 when the opening/closing mechanism is in the opened state, for example. The communication hole 241h also has a function of fixing the opening portion 16p of the general-purpose reagent bottle 160 at a predetermined position (i.e. the position of the communication hole 241h). The opening/closing mechanism of the reagent bottle adapter 240 is configured to change the state of the opening portion 16p of the general-purpose reagent bottle 160 to the opened state or the closed state by sliding the cap member portion 242 in the horizontal direction using the opening/closing portion 243. Thus, the reagent bottle loading device 50 changes (shifts) the state of the opening portion 16p of the general-purpose reagent bottle 160 to the opened state or the closed state by causing the transfer arm 52 to interfere with the opening/closing portion 243 (more specifically, by sliding the cap member portion 242 in the horizontal direction by sliding the opening/closing portion 243 horizontally with the transfer arm 52 so as to slide the cap member portion 242 horizontally). The reagent bottle adapter main body portion 241 is provided with a grip portion 241a to be gripped by the leading end portion 52a of the transfer arm 52 of the reagent bottle loading device 50, for example, and the opening/closing portion 243 is provided with a grip portion 243a to be gripped by the leading end portion 52a of the transfer arm 52, for example. The cap member portion 242 includes, for example, a spring portion 242s that extends in a predetermined state and at a closed state position so that the opening/closing mechanism-equipped reagent bottle 16E is the closed state, and in a case where the cap member portion 242 is slid in the horizontal direction, contracts so that the opening/closing mechanism-equipped reagent bottle 16E is in the opened state. Furthermore, the reagent bottle adapter main body portion 241 is provided with a protrusion-shaped guide portion for holding the opening/closing mechanism-equipped reagent bottle 16E at a position where the opening/closing mechanism-equipped reagent bottle 16E is stored, for example. FIGS. 6A to 6C illustrate a configuration in which the reagent bottle adapter main body portion 241 is provided with two guide portions corresponding to a guide portion 241b and a guide portion 241c to hold the position of the opening/closing mechanism-equipped reagent bottle 16E at two points. The number of guide portions provided in the reagent bottle adapter main body portion 241 may be two or more. In contrast, the first reagent storage 11 and the second reagent storage 12 are each provided with a recess-shaped guide reception portion that engages with a guide portion provided in the reagent bottle adapter main body portion 241, for example. FIGS. 6A to 6C illustrate a configuration in which guide reception portions 114b and 114c that engage with the guide portions 241b and 241c, respectively, of the reagent bottle adapter main body portion 241 at a position where the opening/closing mechanism-equipped reagent bottle 16E is stored are provided in the first reagent storage 11. It is sufficient that the number of guide reception portions provided in each of the first reagent storage 11 and the second reagent storage 12 corresponds to the number of guide portions provided in the reagent bottle adapter main body portion 241.

As with the predetermined state of the reagent bottle adapter 220 or the like, a predetermined state in the opening/closing mechanism of the reagent bottle adapter 240 is also a state in which the communication hole 241h and the communication hole 242h do not communicate with each other, in other words, a state in which the cap member portion 242 blocks the communication hole 241h of the reagent bottle adapter main body portion 241 and lids the general-purpose reagent bottle 160 also in the opening/closing mechanism-equipped reagent bottle 16E. By causing the leading end portion 52a of the transfer arm 52 to grip the grip portion 241a of the opening/closing mechanism-equipped reagent bottle 16E in this predetermined state, the reagent bottle loading device 50 performs removal, transfer, and storing of the opening/closing mechanism-equipped reagent bottle 16E between the first reagent storage 11, the second reagent storage 12, and the reagent replenishment storage (not illustrated). After that, the reagent bottle loading device 50 causes the leading end portion 52a of the transfer arm 52 to grip the grip portion 243a of the opening/closing portion 243. FIG. 6A illustrates a state in which the reagent bottle loading device 50 causes the leading end portion 52a of the transfer arm 52 to grip the grip portion 241a, transfers the opening/closing mechanism-equipped reagent bottle 16E to the first reagent storage 11, stores the opening/closing mechanism-equipped reagent bottle 16E into the first reagent storage 11, and then causes the leading end portion 52a of the transfer arm 52 to grip the grip portion 243a of the opening/closing portion 243.

After that, for example, at an operation timing of the startup operation or the preparation operation of the analyzing device 10, the reagent bottle loading device 50 changes (shifts) the state of the opening/closing mechanism-equipped reagent bottle 16E to the opened state, in other words, changes (shifts) the state of the opening portion 16p of the general-purpose reagent bottle 160 to the opened state, by sliding the opening/closing portion 243 in the horizontal direction using the transfer arm 52 to slide the cap member portion 242 in the horizontal direction. FIG. 6B illustrates a state in which the reagent bottle loading device 50 changes (shifts) the state of the opening/closing mechanism-equipped reagent bottle 16E to the opened state by sliding the opening/closing portion 243 using the transfer arm 52 in a moving direction Dm indicated by an arrow. At this time, in the reagent bottle adapter 240, as illustrated in FIG. 6B, the spring portion 242s has been pushed in and has become compressed due to interference of the opening/closing portion 243 with the cap member portion 242.

After that, the reagent bottle loading device 50 brings the cap member portion 242 into a state in which it has been slid horizontally to a position where the communication hole 241h and the communication hole 242h communicate with each other by sliding the opening/closing portion 243, in other words, the opening portion 16p of the general-purpose reagent bottle 160 is in the opened state, and then releases the grip of the grip portion 243a by the leading end portion 52a of the transfer arm 52. FIG. 6C illustrates a state in which, after the opening/closing mechanism-equipped reagent bottle 16E enters the opened state, the gripping of the grip portion 243a gripped by the leading end portion 52a of the transfer arm 52 is released. With this configuration, for example, the first reagent dispensing arm 21 can aspirate the reagent stored in the general-purpose reagent bottle 160, by inserting the first reagent dispensing probe 31 into the general-purpose reagent bottle 160.

After that, for example, at an operation timing of the shutdown operation of the analyzing device 10, the reagent bottle loading device 50 changes (shifts) the state of the opening/closing mechanism-equipped reagent bottle 16E to the closed state (refer to FIG. 6A) by sliding the opening/closing portion 243 using the transfer arm 52 in the horizontal direction opposite to the moving direction Dm indicated by the arrow in FIG. 6B, thereby sliding the cap member portion 242 in the horizontal direction.

As described above, the opening/closing mechanism according to the fourth embodiment is configured to change the state of the opening portion 16p of the opening/closing mechanism-equipped reagent bottle 16E to which the reagent bottle adapter main body portion 241 is attached, to the opened state or the closed state by sliding the opening/closing portion 243 included in the reagent bottle adapter 240 in the horizontal direction, thereby sliding the cap member portion 242 in the horizontal direction. Additionally, in the opening/closing mechanism according to the fourth embodiment, the reagent bottle loading device 50 can change (shift) the state of the opening portion 16p of the opening/closing mechanism-equipped reagent bottle 16E to the opened state or the closed state by sliding the opening/closing portion 243 of the reagent bottle adapter 240 in the horizontal direction, thereby sliding the cap member portion 242 in the horizontal direction. That is, also in the automated analyzer 1 that performs analysis (measurement) of a test sample in the analyzing device 10 using the reagent bottle 16 including the opening/closing mechanism according to the fourth embodiment, as with the automated analyzer 1 that performs analysis (measurement) of a test sample in the analyzing device 10 using the reagent bottle 16 including the opening/closing mechanism according to the first to the third embodiments, the reagent bottle loading device 50 can automatically change (shift) the state of the opening portion 16p of the reagent bottle 16 to the opened state or the closed state at a required operation timing in the analyzing device 10. With this configuration, also in the automated analyzer 1 that performs analysis (measurement) of a test sample in the analyzing device 10 using the reagent bottle 16 including the opening/closing mechanism according to the fourth embodiment, as with the automated analyzer 1 that performs analysis (measurement) of a test sample in the analyzing device 10 using the reagent bottle 16 including the opening/closing mechanism according to the first to the third embodiments, it is possible to reduce factors that may accelerate degradation of reagent quality during the analysis (measurement) of the test sample.

Moreover, in the opening/closing mechanism according to the fourth embodiment, unlike the opening/closing mechanism according to the first embodiment, the grip portion 243a that the reagent bottle loading device 50 causes the leading end portion 52a of the transfer arm 52 to grip is formed in the opening/closing portion 243, and the transfer arm 52 can change (shift) the opening portion 16p of the opening/closing mechanism-equipped reagent bottle 16E to the opened state or the closed state without a direct interference with the cap member portion 242.

In addition, also in the automated analyzer 1 that performs analysis (measurement) of a test sample in the analyzing device 10 using the reagent bottle 16 including the opening/closing mechanism according to the fourth embodiment, the reagent bottle loading device 50 can automatically change (shift) the state of the opening portion 16p of the reagent bottle 16 to the opened state or the closed state. Thus, as with the automated analyzer 1 that performs analysis (measurement) of a test sample in the analyzing device 10 using the reagent bottle 16 including the opening/closing mechanism according to the first to the third embodiments, it is possible to set a timing of changing (shifting) the state of the opening portion 16p of the reagent bottle 16 to the opened state or the closed state, for each reagent.

In the above-described opening/closing mechanism according to the fourth embodiment, the configuration in which the opening/closing portion 243 is provided in the reagent bottle adapter 240 has been described, but the opening/closing portion 243 may be provided in each of the first reagent storage 11 and the second reagent storage 12. In such a case, it is sufficient for an opening/closing operation of the opening portion 16p of the reagent bottle 16 (the opening/closing mechanism-equipped reagent bottle 16E) performed by the reagent bottle loading device 50 to be equivalent to the above-described opening/closing operation. Thus, the detailed description of an opening/closing operation of the reagent bottle 16 (the opening/closing mechanism-equipped reagent bottle 16E) that is performed in the case of the configuration in which the opening/closing portion 243 is provided in each of the first reagent storage 11 and the second reagent storage 12 will be omitted.

In the above-described opening/closing mechanism according to the fourth embodiment, a description has been provided of a configuration of changing the state of the opening portion 16p of the opening/closing mechanism-equipped reagent bottle 16E to the opened state or the closed state by sliding the opening/closing portion 243 included in the reagent bottle adapter 240 in the horizontal direction to slide the cap member portion 242 in the horizontal direction. Nevertheless, also in the opening/closing mechanism according to the fourth embodiment, as with the opening/closing mechanism according to the first embodiment and the opening/closing mechanism according to the second embodiment, the configuration of changing the state of the opening portion 16p of the reagent bottle 16 to the opened state or the closed state is not limited to the configuration realized by sliding the grip portion 243a in the horizontal direction to slide the cap member portion 242 in the horizontal direction. For example, the state of the opening portion 16p of the opening/closing mechanism-equipped reagent bottle 16E may be changed to the opened state or the closed state by rotating the grip portion 243a in the horizontal direction to rotate the cap member portion 242 in the horizontal direction.

In the above-described opening/closing mechanism according to the fourth embodiment, a description has been provided of the configuration in which the reagent bottle 16 including an opening/closing mechanism (the opening/closing mechanism-equipped reagent bottle 16E) is formed by attaching the reagent bottle adapter 240 to the general-purpose reagent bottle 160. Alternatively, as with the opening/closing mechanism according to the first to the third embodiments, the dedicated reagent bottle 16 integrated with an opening/closing mechanism may be employed. In this case, the configuration can be realized by integrating an opening/closing mechanism having a structure similar to that of the reagent bottle adapter 240 with the main body of the reagent bottle, adopting an idea similar to the opening/closing mechanism according to the first embodiment, for example. Thus, the detailed description of an example of a configuration of the dedicated reagent bottle 16 integrated with an opening/closing mechanism with a structure similar to that of the reagent bottle adapter 240 will be omitted.

The reagent bottle adapter 240 is an example of an “opening/closing mechanism” and a “reagent bottle adapter”. The opening/closing mechanism-equipped reagent bottle 16E is an example of a “reagent bottle including an opening/closing mechanism”. The opening/closing portion 243 (including the grip portion 243a) is an example of an “interference unit that interferes with a part of an opening/closing mechanism”.

### Fifth Embodiment

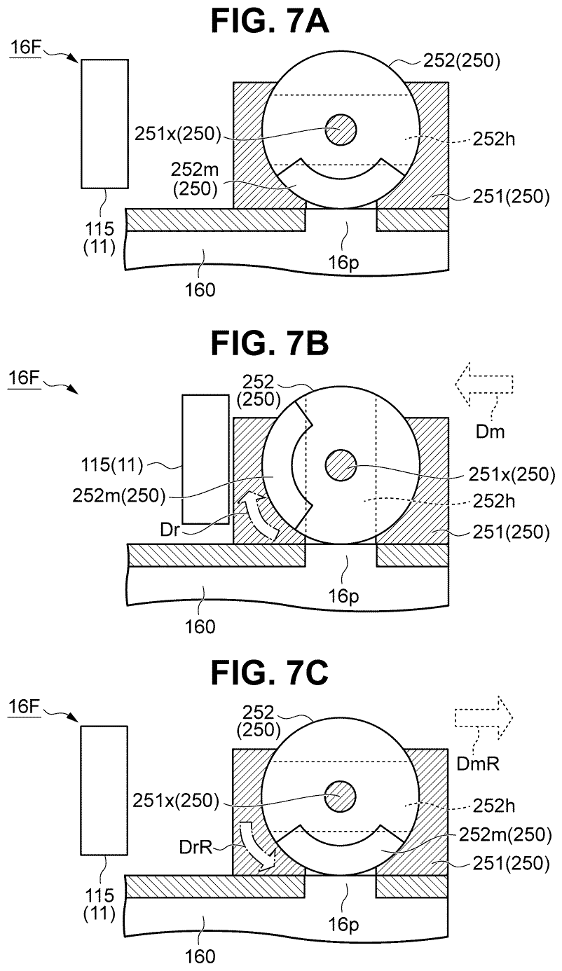

FIG. 7 is a diagram schematically illustrating an example of a structure and an opening/closing operation of an opening/closing mechanism of a reagent bottle according to a fifth embodiment. FIGS. 7A to 7C illustrate an enlarged view of the opening portion 16p of the general-purpose reagent bottle 160 and the periphery thereof in an example in which a reagent bottle 16 including an opening/closing mechanism (hereinafter, referred to as an “opening/closing mechanism-equipped reagent bottle 16F”) is formed by attaching a reagent bottle adapter 250 including an opening/closing mechanism to the general-purpose reagent bottle 160.

The reagent bottle adapter 250 includes, for example, a reagent bottle adapter main body portion 251 and a cap member portion 252. The reagent bottle adapter main body portion 251 is provided with a rotational shaft 251x that supports the cap member portion 252 so that the cap member portion 252 rotates in a fixed direction, for example. The cap member portion 252 is a member having a spherical shape or a cylindrical shape, for example, and has a communication hole 252h that communicates with the opening portion 16p of the general-purpose reagent bottle 160 when the opening/closing mechanism is in the opened state. The cap member portion 252 further includes a magnetic member 252m which is attracted by a magnet or the like, for example. The reagent bottle adapter main body portion 251 may optionally be provided with a communication hole also having a function of fixing the opening portion 16p of the general-purpose reagent bottle 160 at a predetermined position (i.e. the position of the communication hole 252h that is set when the opening/closing mechanism is brought into the opened state). The opening/closing mechanism of the reagent bottle adapter 250 is configured to change the state of the opening portion 16p of the general-purpose reagent bottle 160 to the opened state or the closed state by rotating the cap member portion 252 in the reagent bottle adapter main body portion 251. Thus, the first reagent storage 11 and the second reagent storage 12 are each provided with a magnet portion 115 for attracting the magnetic member 252m included in the cap member portion 252, for example, and the reagent bottle loading device 50 moves the opening/closing mechanism-equipped reagent bottle 16F to either a position where the magnetic member 252m is attracted by the magnet portion 115 or a position where the magnetic member 252m is not attracted by the magnet portion 115, by moving the entire opening/closing mechanism-equipped reagent bottle 16F in the horizontal direction using the transfer arm 52. The position where the magnetic member 252m is attracted by the magnet portion 115 corresponds to an opened state position of the opening/closing mechanism-equipped reagent bottle 16F where the opening portion 16p of the general-purpose reagent bottle 160 is in the opened state. The position where the magnetic member 252m is not attracted by the magnet portion 115 corresponds to a closed state position of the opening/closing mechanism-equipped reagent bottle 16F, where the opening portion 16p of the general-purpose reagent bottle 160 is in the closed state. Thus, as with the opening/closing mechanism according to the first to the fourth embodiments, the reagent bottle adapter main body portion 251 is provided with a grip portion (not illustrated) (hereinafter, referred to as a “grip portion 251a”) to be gripped by the leading end portion 52a of the transfer arm 52 of the reagent bottle loading device 50, for example. Additionally, each of the first reagent storage 11 and the second reagent storage 12, and the reagent bottle adapter main body portion 251 are provided with a configuration (not illustrated) for holding the opening/closing mechanism-equipped reagent bottle 16F at the closed state position or the opened state position, for example. This configuration may be a combination of a guide portion and a guide reception portion that is similar to the configuration of holding the opening/closing mechanism-equipped reagent bottle 16C in the opening/closing mechanism according to the second embodiment, or may be a combination of a protrusion-shaped insertion portion and a groove portion that is similar to the configuration of holding the opening/closing mechanism-equipped reagent bottle 16D in the opening/closing mechanism according to the third embodiment.

As with the predetermined state of the reagent bottle adapter 220 or the like, a predetermined state in the opening/closing mechanism of the reagent bottle adapter 250 is also a state in which the opening portion 16p of the general-purpose reagent bottle 160 does not communicate with the communication hole 252h, in other words, a state in which the cap member portion 252 blocks the opening portion 16p and lids the general-purpose reagent bottle 160, also in the opening/closing mechanism-equipped reagent bottle 16F. The magnetic member 252m is moved toward the opening portion 16p, in other words, toward the general-purpose reagent bottle 160, in accordance with gravitational force, so that the cap member portion 252 brings the opening portion 16p of the general-purpose reagent bottle 160 into the closed state. The reagent bottle loading device 50 causes the leading end portion 52a of the transfer arm 52 to grip the grip portion 251a of the opening/closing mechanism-equipped reagent bottle 16F in this predetermined state to perform removal, transfer, and storing of the opening/closing mechanism-equipped reagent bottle 16F between the first reagent storage 11, the second reagent storage 12, and the reagent replenishment storage (not illustrated). FIG. 7A illustrates a state in which the reagent bottle loading device 50 causes the leading end portion 52a of the transfer arm 52 to grip the grip portion 251a to transfer the opening/closing mechanism-equipped reagent bottle 16F to the first reagent storage 11 or the second reagent storage 12 (here, assumed to be the first reagent storage 11).

After that, for example, at the time of the startup operation or the preparation operation of the analyzing device 10, the reagent bottle loading device 50 brings the cap member portion 252 closer to the magnet portion 115 by moving the entire opening/closing mechanism-equipped reagent bottle 16F in the horizontal direction using the transfer arm 52. With this configuration, the magnetic member 252m is attracted by the magnet portion 115, so that the cap member portion 252 rotates accordingly about the rotational shaft 251x, and the communication hole 252h communicates with the opening portion 16p of the general-purpose reagent bottle 160, thus changing (shifting) the state of the opening/closing mechanism-equipped reagent bottle 16F to the opened state. FIG. 7B illustrates a state in which the opening/closing mechanism-equipped reagent bottle 16F has been changed to the opened state in which the communication hole 252h communicates with the opening portion 16p. This state is obtained by the reagent bottle loading device 50 moving the opening/closing mechanism-equipped reagent bottle 16F in the moving direction Dm indicated by a broken-line arrow and bringing it close to the magnet portion 115, causing the cap member portion 252 to rotate in the rotational direction Dr indicated by the dash-dotted arrow. With this configuration, for example, the first reagent dispensing arm 21 can aspirate the reagent stored in the general-purpose reagent bottle 160 by inserting the first reagent dispensing probe 31 into the general-purpose reagent bottle 160.

After that, for example, at an operation timing of the shutdown operation of the analyzing device 10, the reagent bottle loading device 50 brings the cap member portion 252 away from the magnet portion 115 by moving the cap member portion 252 using the transfer arm 52 in a direction opposite to the moving direction Dm indicated by the broken line arrow in FIG. 7B. With this configuration, magnetic force by which the magnet portion 115 attracts the magnetic member 252m is reduced, the cap member portion 252 accordingly rotates about the rotational shaft 251x by the own weight of the magnetic member 252m, and the state of the opening/closing mechanism-equipped reagent bottle 16F is changed (shifted) to the closed state in which the communication hole 252h does not communicate with the opening portion 16p of the general-purpose reagent bottle 160. FIG. 7C illustrates a state in which the state of the opening/closing mechanism-equipped reagent bottle 16F has been changed (shifted) to the closed state in which the communication hole 252h and the opening portion 16p do not communicate with each other. This state is obtained by the reagent bottle loading device 50 moving the opening/closing mechanism-equipped reagent bottle 16F in a moving direction DmR indicated by a broken line arrow, and bringing the opening/closing mechanism-equipped reagent bottle 16F away from the magnet portion 115, causing the cap member portion 252 to rotate in a rotational direction DrR indicated by a dashed-dotted line arrow.

As described above, the opening/closing mechanism according to the fifth embodiment is configured to change the state of the opening portion 16p of the general-purpose reagent bottle 160 to the opened state or the closed state by horizontally moving the entire opening/closing mechanism-equipped reagent bottle 16F to which the reagent bottle adapter 250 is attached so as to change the distance between the magnetic member 252m and the magnet portion 115, thereby rotating the cap member portion 252 in the reagent bottle adapter main body portion 251. In the opening/closing mechanism according to the fifth embodiment, the reagent bottle loading device 50 can change (shift) the state of the opening portion 16p of the opening/closing mechanism-equipped reagent bottle 16F to the opened state or the closed state by moving the entire opening/closing mechanism-equipped reagent bottle 16F in the horizontal direction so as to change the magnetic force of the magnet portion 115 that attracts the magnetic member 252m. In other words, also in the automated analyzer 1 that performs analysis (measurement) of a test sample in the analyzing device 10 using the reagent bottle 16 including the opening/closing mechanism according to the fifth embodiment, as with the automated analyzer 1 that performs analysis (measurement) of a test sample in the analyzing device 10 using the reagent bottle 16 including the opening/closing mechanism according to the first to the fourth embodiments, at a required operation timing in the analyzing device 10, the reagent bottle loading device 50 can automatically change (shift) the state of the opening portion 16p of the reagent bottle 16 to the opened state or the closed state. With this configuration, also in the automated analyzer 1 that performs analysis (measurement) of a test sample in the analyzing device 10 using the reagent bottle 16 including the opening/closing mechanism according to the fifth embodiment, as with the automated analyzer 1 that performs analysis (measurement) of a test sample in the analyzing device 10 using the reagent bottle 16 including the opening/closing mechanism according to the first to the fourth embodiments, it is possible to reduce factors that may accelerate degradation of reagent quality during the analysis (measurement) of the test sample.

Further, also in the automated analyzer 1 that performs analysis (measurement) of a test sample in the analyzing device 10 using the reagent bottle 16 including the opening/closing mechanism according to the fifth embodiment, the reagent bottle loading device 50 can automatically change (shift) the state of the opening portion 16p of the reagent bottle 16 to the opened state or the closed state. Thus, as with the automated analyzer 1 that performs analysis (measurement) of a test sample in the analyzing device 10 using the reagent bottle 16 including the opening/closing mechanism according to the first to the fourth embodiments, it is possible to set a timing of changing (shifting) the state of the opening portion 16p of the reagent bottle 16 to the opened state or the closed state, for each reagent.

In the above-described opening/closing mechanism according to the fifth embodiment, a description has been provided of a configuration of changing the state of the opening portion 16p of the opening/closing mechanism-equipped reagent bottle 16F to the opened state or the closed state by moving, in the horizontal direction, the entire opening/closing mechanism-equipped reagent bottle 16F to which the reagent bottle adapter 250 is attached to change a distance between the magnetic member 252m and the magnet portion 115. In other words, a configuration to be employed in a case where the magnet portion 115 is assumed to be a permanent magnet has been described. Nevertheless, the magnet portion 115 that changes the state of the opening portion 16p of the opening/closing mechanism-equipped reagent bottle 16F to the opened state or the closed state in the opening/closing mechanism according to the fifth embodiment is not necessarily limited to a permanent magnet. For example, a configuration of using an electromagnet whose generation of magnetic force is controlled in accordance with control from the analysis control function 144 in the processing circuitry 140 included in the control device 100 (control executed by the transfer control function 1448) may be employed. In this case, after transferring the opening/closing mechanism-equipped reagent bottle 16F and storing the opening/closing mechanism-equipped reagent bottle 16F into the first reagent storage 11 or the second reagent storage 12, the reagent bottle loading device 50 does not necessarily need to move the opening/closing mechanism-equipped reagent bottle 16F, and the state of the opening portion 16p of the opening/closing mechanism-equipped reagent bottle 16F can be changed to the opened state or the closed state by the analysis control function 144 controlling generation of magnetic force by the electromagnet.

In the opening/closing mechanism according to the above-described fifth embodiment, the configuration to be employed in a case where the reagent bottle 16 including an opening/closing mechanism (the opening/closing mechanism-equipped reagent bottle 16F) is formed by attaching the reagent bottle adapter 250 to the general-purpose reagent bottle 160 has been described, but as with the opening/closing mechanism according to the first to the fourth embodiments, the dedicated reagent bottle 16 integrated with an opening/closing mechanism may be employed. In such a case, the cap member portion 252 included in the reagent bottle adapter 250 may be provided in the opening portion 16p. In this case, the configuration can be realized by integrating an opening/closing mechanism having a structure similar to that of the reagent bottle adapter 250 with the main body of the reagent bottle, adopting an idea similar to the opening/closing mechanism according to the first embodiment, for example. Thus, a detailed description of an example of the configuration of a dedicated reagent bottle 16 in which an opening/closing mechanism having a structure similar to that of the reagent bottle adapter 250 is integrated will be omitted.

The reagent bottle adapter 250 is an example of an “opening/closing mechanism” and a “reagent bottle adapter”. The opening/closing mechanism-equipped reagent bottle 16F is an example of a “reagent bottle including an opening/closing mechanism”. The magnetic member 252m is an example of a “magnetic member”. The magnet portion 115 is an example of a “magnet portion”.

### Sixth Embodiment

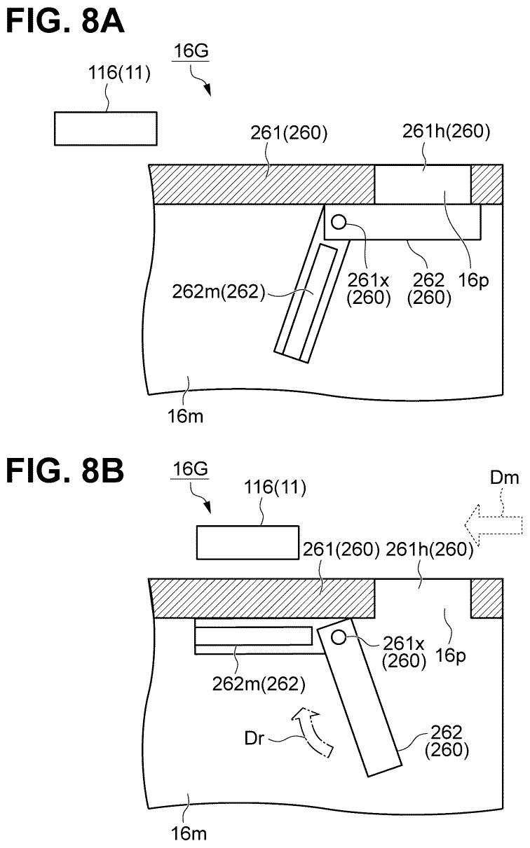

FIGS. 8A and 8B are diagrams schematically illustrating an example of a structure and an opening/closing operation of an opening/closing mechanism of a reagent bottle according to the sixth embodiment. FIGS. 8A and 8B illustrate an enlarged view of the opening portion 16p of the reagent bottle main body portion 16m and the periphery thereof 16p in an example case where a dedicated reagent bottle 16 including an opening/closing mechanism (hereinafter, referred to as an “opening/closing mechanism-equipped reagent bottle 16G”) is formed by integrally forming a reagent bottle main body portion 16m and an opening/closing mechanism (hereinafter, referred to as an “opening/closing mechanism 260”).

The opening/closing mechanism 260 includes, for example, an opening/closing mechanism main body portion 261 and a cap member portion 262. The opening/closing mechanism main body portion 261 is provided with a communication hole 261h that communicates with the opening portion 16p of the reagent bottle main body portion 16m when the opening/closing mechanism 260 is in the opened state, and a rotational shaft 261x that supports the cap member portion 262 so that the cap member portion 262 rotates in a fixed direction, for example. The cap member portion 262 is a member having a shape that allows the cap member portion 262 to rotate about the rotational shaft 261x to bring the communication hole 261h and the opening portion 16p into communication with each other or to close the communication hole 261h. The cap member portion 262 is provided with a magnetic member 262m that is attracted by a magnet or the like, for example, when the opening/closing mechanism 260 is brought into the opened state. The opening/closing mechanism 260 is configured to change the state of the opening portion 16p of the reagent bottle main body portion 16m to the opened state or the closed state by rotating the cap member portion 262 in the reagent bottle main body portion 16m. Thus, the first reagent storage 11 and the second reagent storage 12 are each provided with a magnet portion 116 for attracting the magnetic member 262m included in the cap member portion 262, for example, and the reagent bottle loading device 50 moves the opening/closing mechanism-equipped reagent bottle 16G to either a position where the magnetic member 262m is attracted by the magnet portion 116 or a position where the magnetic member 262m is not attracted by the magnet portion 116, by moving the entire opening/closing mechanism-equipped reagent bottle 16G in the horizontal direction using the transfer arm 52. The position where the magnetic member 262m is attracted by the magnet portion 116 is an opened state position of the opening/closing mechanism-equipped reagent bottle 16G where the opening portion 16p of the reagent bottle main body portion 16m is brought into the opened state, and the position where the magnetic member 262m is not attracted by the magnet portion 116 is a closed state position of the opening/closing mechanism-equipped reagent bottle 16G where the opening portion 16p of the reagent bottle main body portion 16m is brought into the closed state. Thus, as with the opening/closing mechanism according to the first to the fifth embodiments, the opening/closing mechanism main body portion 261 is provided with a grip portion (not illustrated) (hereinafter, referred to as a “grip portion 261a”) to be gripped by the leading end portion 52a of the transfer arm 52 of the reagent bottle loading device 50, for example. In addition, each of the first reagent storage 11 and the second reagent storage 12, and the opening/closing mechanism main body portion 261 are provided with a configuration (not illustrated) for holding the opening/closing mechanism-equipped reagent bottle 16G at the closed state position or the opened state position, for example. This configuration may be a combination of a guide portion and a guide reception portion that is similar to the configuration of holding the opening/closing mechanism-equipped reagent bottle 16C in the opening/closing mechanism according to the second embodiment, or may be a combination of a protrusion-shaped insertion portion and a groove portion that is similar to the configuration of holding the opening/closing mechanism-equipped reagent bottle 16D in the opening/closing mechanism according to the third embodiment.

As with the predetermined state of the reagent bottle adapter 220 or the like, a predetermined state in the opening/closing mechanism of the opening/closing mechanism 260 is also a state in which the opening portion 16p of the reagent bottle main body portion 16m does not communicate with the communication hole 261h, in other words, a state in which the cap member portion 262 blocks the opening portion 16p and lids the reagent bottle main body portion 16m, also in the opening/closing mechanism-equipped reagent bottle 16G. The cap member portion 262 brings the opening portion 16p of the reagent bottle main body portion 16m into the closed state by the magnetic member 262m moving toward the inside of the reagent bottle main body portion 16m in accordance with gravitational force. By causing the leading end portion 52a of the transfer arm 52 to grip the grip portion 261a of the opening/closing mechanism-equipped reagent bottle 16G in this predetermined state, the reagent bottle loading device 50 performs removal, transfer, and storing of the opening/closing mechanism-equipped reagent bottle 16G between the first reagent storage 11, the second reagent storage 12, and the reagent replenishment storage (not illustrated). FIG. 8A illustrates a state in which the reagent bottle loading device 50 causes the leading end portion 52a of the transfer arm 52 to grip the grip portion 261a, and the opening/closing mechanism-equipped reagent bottle 16G is transferred to the first reagent storage 11 or the second reagent storage 12 (here, assumed to be the first reagent storage 11).

After that, for example, at an operation timing of the startup operation or the preparation operation of the analyzing device 10, the reagent bottle loading device 50 brings the cap member portion 262 closer to the magnet portion 116 by moving the entire opening/closing mechanism-equipped reagent bottle 16G in the horizontal direction using the transfer arm 52. With this configuration, the magnetic member 262m is attracted by the magnet portion 116, the cap member portion 262 accordingly rotates about the rotational shaft 261x, the communication hole 261h communicates with the opening portion 16p of the reagent bottle main body portion 16m, and the state of the opening/closing mechanism-equipped reagent bottle 16G is changed (shifted) to the opened state. FIG. 8B illustrates a state in which the state of the opening/closing mechanism-equipped reagent bottle 16G has been changed (shifted) to the opened state in which the communication hole 261h and the opening portion 16p communicate with each other. This state is obtained by the reagent bottle loading device 50 moving the opening/closing mechanism-equipped reagent bottle 16G in a moving direction Dm indicated by a broken line arrow and bringing the opening/closing mechanism-equipped reagent bottle 16G closer to the magnet portion 116 so as to rotate the cap member portion 262 in a rotational direction Dr indicated by a dashed-dotted line arrow. With this configuration, for example, the first reagent dispensing arm 21 can aspirate a reagent stored in the reagent bottle main body portion 16m, by inserting the first reagent dispensing probe 31 into the reagent bottle main body portion 16m.

After that, for example, at an operation timing of the shutdown operation of the analyzing device 10, the reagent bottle loading device 50 brings the cap member portion 262 away from the magnet portion 116 by moving the cap member portion 262 using the transfer arm 52 in a direction opposite to the moving direction Dm indicated by the broken line arrow in FIG. 8B. With this configuration, magnetic force by which the magnet portion 116 attracts the magnetic member 262m reduces, the cap member portion 262 accordingly rotates about the rotational shaft 261x by the own weight of the magnetic member 262m, and the state of the opening/closing mechanism-equipped reagent bottle 16G is changed (shifted) to the closed state in which the communication hole 261h does not communicate with the opening portion 16p of the reagent bottle main body portion 16m. The state at this time is the same state as the state illustrated in FIG. 8A.

As described above, the opening/closing mechanism according to the sixth embodiment is configured to change the state of the opening portion 16p of the reagent bottle main body portion 16m to the opened state or the closed state by horizontally moving the entire opening/closing mechanism-equipped reagent bottle 16G integrally formed with the opening/closing mechanism 260 to change the distance between the magnetic member 262m and the magnet portion 116 so as to rotate the cap member portion 262 in the reagent bottle main body portion 16m. In addition, in the opening/closing mechanism according to the sixth embodiment, the reagent bottle loading device 50 can change (shift) the state of the opening portion 16p of the opening/closing mechanism-equipped reagent bottle 16G to the opened state or the closed state by moving the entire opening/closing mechanism-equipped reagent bottle 16G in the horizontal direction to change the magnetic force of the magnet portion 116 that attracts the magnetic member 262m. In other words, also in the automated analyzer 1 that performs analysis (measurement) of a test sample in the analyzing device 10 using the reagent bottle 16 including the opening/closing mechanism according to the sixth embodiment, as with the automated analyzer 1 that performs analysis (measurement) of a test sample in the analyzing device 10 using the reagent bottle 16 including the opening/closing mechanism according to the first to the fifth embodiments, at a required operation timing in the analyzing device 10, the reagent bottle loading device 50 can automatically change (shift) the state of the opening portion 16p of the reagent bottle 16 to the opened state or the closed state. With this configuration, also in the automated analyzer 1 that performs analysis (measurement) of a test sample in the analyzing device 10 using the reagent bottle 16 including the opening/closing mechanism according to the sixth embodiment, as with the automated analyzer 1 that performs analysis (measurement) of a test sample in the analyzing device 10 using the reagent bottle 16 including the opening/closing mechanism according to the first to the fifth embodiments, it is possible to reduce factors that may accelerate degradation of reagent quality during the analysis (measurement) of a test sample.

Additionally, also in the automated analyzer 1 that performs analysis (measurement) of a test sample in the analyzing device 10 using the reagent bottle 16 including the opening/closing mechanism according to the sixth embodiment, the reagent bottle loading device 50 can automatically change (shift) the state of the opening portion 16p of the reagent bottle 16 to the opened state or the closed state. Thus, as with the automated analyzer 1 that performs analysis (measurement) of a test sample in the analyzing device 10 using the reagent bottle 16 including the opening/closing mechanism according to the first to the fifth embodiments, it is possible to set a timing of changing (shifting) the state of the opening portion 16p of the reagent bottle 16 to the opened state or the closed state, for each reagent.

In the opening/closing mechanism according to the above-described sixth embodiment, a description has been provided of a configuration of changing the state of the opening portion 16p of the opening/closing mechanism-equipped reagent bottle 16G to the opened state or the closed state by moving, in the horizontal direction, the entire opening/closing mechanism-equipped reagent bottle 16G integrated with the opening/closing mechanism 260 to change a distance between the magnetic member 262m and the magnet portion 116. In other words, as with the fifth embodiment, a configuration in a case where the magnet portion 116 is assumed to be a permanent magnet has been described. The magnet portion 116 that changes the state of the opening portion 16p of the opening/closing mechanism-equipped reagent bottle 16G to the opened state or the closed state in the opening/closing mechanism according to the sixth embodiment is not limited to a permanent magnet, as with the fifth embodiment. An electromagnet to be controlled whether to generate magnetic force may be employed. In this case, after transferring the opening/closing mechanism-equipped reagent bottle 16G and storing the opening/closing mechanism-equipped reagent bottle 16G into the first reagent storage 11 or the second reagent storage 12, as with the fifth embodiment, the reagent bottle loading device 50 does not necessarily need to move the opening/closing mechanism-equipped reagent bottle 16G, and the state of the opening portion 16p of the opening/closing mechanism-equipped reagent bottle 16G can be changed to the opened state or the closed state by the analysis control function 144 controlling generation of magnetic force by the permanent magnet.

The opening/closing mechanism 260 is an example of an “opening/closing mechanism”. The opening/closing mechanism-equipped reagent bottle 16G is an example of a “reagent bottle including an opening/closing mechanism”. The magnetic member 262m is an example of a “magnetic member”. The magnet portion 116 is an example of a “magnet portion”.

### Seventh Embodiment

FIGS. 9A-1 to 9B-2 are diagrams schematically illustrating an example of a structure and an opening/closing operation of an opening/closing mechanism of a reagent bottle according to a seventh embodiment. FIGS. 9A-1 to 9B-2 illustrate an enlarged view of the opening portion 16p of the general-purpose reagent bottle 160 and the periphery thereof in an example case where a reagent bottle 16 including an opening/closing mechanism (hereinafter, referred to as an “opening/closing mechanism-equipped reagent bottle 16H”) is formed by attaching a reagent bottle adapter 270 including an opening/closing mechanism, to the general-purpose reagent bottle 160.

The reagent bottle adapter 270 includes, for example, a reagent bottle adapter main body portion 271 and a cap member portion 272. The reagent bottle adapter main body portion 271 is provided with a rotational shaft 271x that supports the cap member portion 272 so that the cap member portion 272 rotates in a fixed direction, for example. The cap member portion 272 is provided with a gear part 272p that rotates about the rotational shaft 271x, a serrated opening/closing portion 272r that includes teeth linearly formed and to be engaged with teeth formed in the gear part 272p, and rotates the gear part 272p by a linear movement, and a cap member 272l that rotates in the up-down direction in accordance with the rotation of the gear part 272p, and brings the opening portion 16p of the general-purpose reagent bottle 160 into the opened state or the closed state, for example. The serrated opening/closing portion 272r is provided with a grip portion 272a to be gripped by the leading end portion 52a of the transfer arm 52 of the reagent bottle loading device 50, for example. The opening/closing mechanism of the reagent bottle adapter 270 is configured to rotate the gear part 272p by sliding the serrated opening/closing portion 272r in the horizontal direction, and this rotation of the gear part 272p changes the state of the opening portion 16p of the general-purpose reagent bottle 160 to the opened state or the closed state. In other words, the opening/closing mechanism of the reagent bottle adapter 270 is configured to change the state of the opening portion 16p of the general-purpose reagent bottle 160 to the opened state or the closed state by a mechanism commonly referred to as a rack-and-pinion mechanism, including the serrated opening/closing portion 272r and the gear part 272p. FIGS. 9A-1 to 9B-2 illustrate a configuration in which the serrated opening/closing portion 272r is integrated with a main body portion of the cap member portion 272, that is, the cap member portion 272 has a rack mechanism. For this reason, the reagent bottle loading device 50 changes (shifts) the state of the opening portion 16p of the general-purpose reagent bottle 160 to the opened state or the closed state by causing the transfer arm 52 to interfere with the serrated opening/closing portion 272r (more specifically, by sliding the serrated opening/closing portion 272r in the horizontal direction using the transfer arm 52). The serrated opening/closing portion 272r is provided with the grip portion 272a to be gripped by the leading end portion 52a of the transfer arm 52 of the reagent bottle loading device 50, for example. As with the opening/closing mechanism according to the first to the sixth embodiments, the reagent bottle adapter main body portion 271 is provided with a grip portion (not illustrated) (hereinafter, referred to as a “grip portion 271a”) to be gripped by the leading end portion 52a of the transfer arm 52 of the reagent bottle loading device 50, for example.

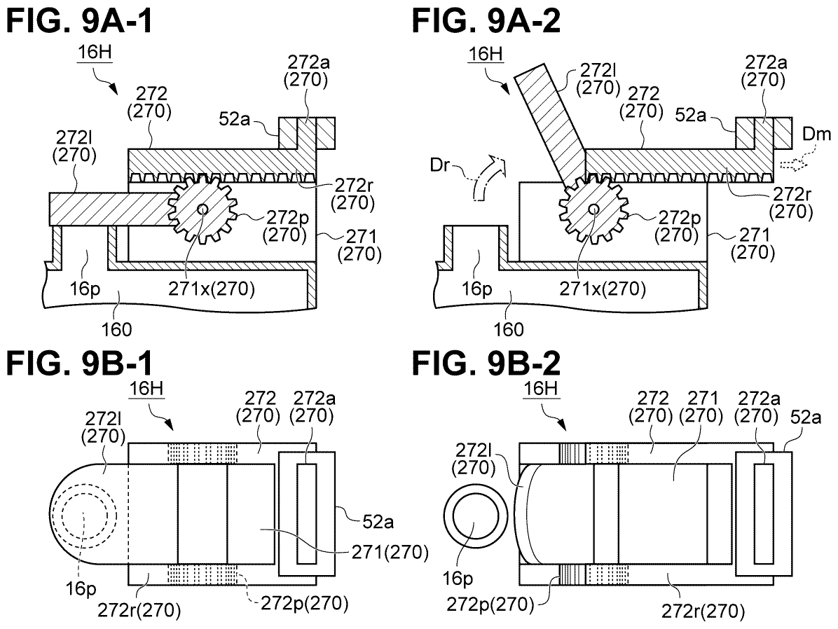

As with the predetermined state of the reagent bottle adapter 220 or the like, a predetermined state in the opening/closing mechanism of the reagent bottle adapter 270 is also a state in which the opening portion 16p of the general-purpose reagent bottle 160 is in the closed state, in other words, a state in which the cap member 272l blocks the opening portion 16p and lids the general-purpose reagent bottle 160 in the opening/closing mechanism-equipped reagent bottle 16H). By causing the leading end portion 52a of the transfer arm 52 to grip the grip portion 271a of the opening/closing mechanism-equipped reagent bottle 16H in this predetermined state, the reagent bottle loading device 50 performs removal, transfer, and storing of the opening/closing mechanism-equipped reagent bottle 16H between the first reagent storage 11, the second reagent storage 12, and the reagent replenishment storage (not illustrated). FIG. 9A-1 illustrates a state in which the reagent bottle loading device 50 transfers the opening/closing mechanism-equipped reagent bottle 16H to the first reagent storage 11 or the second reagent storage 12 (e.g., assumed to be the first reagent storage 11), and then causes the leading end portion 52a of the transfer arm 52 to grip the grip portion 272a. Furthermore, FIG. 9B-1 illustrates a positional relationship between the serrated opening/closing portion 272r, the gear part 272p, and the cap member 272l in the opening/closing mechanism-equipped reagent bottle 16H when the state illustrated in FIG. 9A-1 is viewed from the upper side (side from which the first reagent dispensing probe 31 is inserted), and a state in which the cap member 272l has brought the opening portion 16p into the closed state.

After that, for example, at an operation timing of the startup operation or the preparation operation of the analyzing device 10, the reagent bottle loading device 50 changes (shifts) the state of the opening portion 16p of the general-purpose reagent bottle 160 to the opened state, that is, changes (shifts) the state of the opening/closing mechanism-equipped reagent bottle 16H to the opened state, by sliding the serrated opening/closing portion 272r in the horizontal direction using the transfer arm 52. FIG. 9A-2 illustrate a state in which the opening portion 16p of the general-purpose reagent bottle 160 has been changed (shifted) to the opened state. This state is obtained by the reagent bottle loading device 50 sliding the gripped grip portion 272a in a moving direction Dm indicated by a broken line arrow to rotate the cap member 272l in a rotational direction Dr indicated by a dashed-dotted line arrow. Furthermore, FIG. 9B-2 illustrates a positional relationship between the serrated opening/closing portion 272r, the gear part 272p, and the cap member 272l in the opening/closing mechanism-equipped reagent bottle 16H when the state illustrated in FIG. 9A-2 is viewed from the upper side, and a state in which the cap member 272l has brought the opening portion 16p into the closed state. With this configuration, for example, the first reagent dispensing arm 21 can aspirate a reagent stored in the general-purpose reagent bottle 160, by inserting the first reagent dispensing probe 31 into the general-purpose reagent bottle 160.

After that, for example, at an operation timing of the shutdown operation of the analyzing device 10, the reagent bottle loading device 50 changes (shifts) the state of the opening portion 16p of the general-purpose reagent bottle 160 to the closed state (refer to FIGS. 9A-1 and 9B-1)) by sliding the gripped grip portion 272a using the transfer arm 52 in a direction opposite to the moving direction Dm indicated by the broken line arrow in FIG. 9A-2.

As described above, the opening/closing mechanism according to the seventh embodiment has a configuration in which the opening/closing mechanism rotates the gear part 272p by sliding, in the horizontal direction, the serrated opening/closing portion 272r included in the reagent bottle adapter 270, and, along with the rotation of the gear part 272p, the cap member 272l changes the state of the opening portion 16p of the general-purpose reagent bottle 160 to which the reagent bottle adapter main body portion 271 is attached, to the opened state or the closed state. Then, in the opening/closing mechanism according to the seventh embodiment, the reagent bottle loading device 50 slides the grip portion 272a of the reagent bottle adapter 270 in the horizontal direction so as to slide the serrated opening/closing portion 272r in the horizontal direction, and, in accordance with this sliding, rotates the gear part 272p so as to rotate the cap member 272l in the up-down direction, thus changing (shifting) the state of the opening portion 16p of the opening/closing mechanism-equipped reagent bottle 16H to the opened state or the closed state. That is, also in the automated analyzer 1 that performs analysis (measurement) of a test sample in the analyzing device 10 using the reagent bottle 16 including the opening/closing mechanism according to the seventh embodiment, as with the automated analyzer 1 that performs analysis (measurement) of a test sample in the analyzing device 10 using the reagent bottle 16 including the opening/closing mechanism according to the first to the sixth embodiments, at a required operation timing in the analyzing device 10, the reagent bottle loading device 50 can automatically change (shift) the state of the opening portion 16p of the reagent bottle 16 to the opened state or the closed state. With this configuration, also in the automated analyzer 1 that performs analysis (measurement) of a test sample in the analyzing device 10 using the reagent bottle 16 including the opening/closing mechanism according to the seventh embodiment, as with the automated analyzer 1 that performs analysis (measurement) of a test sample in the analyzing device 10 using the reagent bottle 16 including the opening/closing mechanism according to the first to the sixth embodiments, it is possible to reduce factors that may accelerate degradation of reagent quality during the analysis (measurement) of a test sample.

Then, also in the automated analyzer 1 that performs analysis (measurement) of a test sample in the analyzing device 10 using the reagent bottle 16 including the opening/closing mechanism according to the seventh embodiment, the reagent bottle loading device 50 can automatically change (shift) the state of the opening portion 16p of the reagent bottle 16 to the opened state or the closed state. Thus, as with the automated analyzer 1 that performs analysis (measurement) of a test sample in the analyzing device 10 using the reagent bottle 16 including the opening/closing mechanism according to the first to the sixth embodiments, it is possible to set a timing of changing (shifting) the state of the opening portion 16p of the reagent bottle 16 to the opened state or the closed state, for each reagent.

In the opening/closing mechanism according to the above-described seventh embodiment, the opening portion 16p of the opening/closing mechanism-equipped reagent bottle 16H is changed to the opened state or the closed state by sliding the grip portion 272a of the reagent bottle adapter 270 horizontally to slide the serrated opening/closing portion 272r horizontally, thereby rotating the gear part 272p about the rotational shaft 271x and rotating the cap member 272l vertically. Nevertheless, also in the opening/closing mechanism according to the seventh embodiment, as with the opening/closing mechanism according to the first embodiment, the opening/closing mechanism according to the second embodiment, and the opening/closing mechanism according to the fourth embodiment, the configuration of changing the state of the opening portion 16p of the reagent bottle 16 to the opened state or the closed state is not limited to the configuration of sliding the grip portion 272a in the horizontal direction. For example, the state of the opening portion 16p of the opening/closing mechanism-equipped reagent bottle 16H may be changed to the opened state or the closed state by rotating the grip portion 272a in the horizontal direction to slide the serrated opening/closing portion 272r in the horizontal direction, thereby further rotating the gear part 272p and rotating the cap member 272l in the up-down direction.

In the opening/closing mechanism according to the above-described seventh embodiment, the configuration in which the reagent bottle 16 (opening/closing mechanism-equipped reagent bottle 16H) is formed by attaching the reagent bottle adapter 270 to the general-purpose reagent bottle 160 has been described. As with the opening/closing mechanisms according to the first to fifth embodiments, a dedicated reagent bottle 16 integrated with an opening/closing mechanism may also be employed. In this case, the configuration can be realized by integrating an opening/closing mechanism having a structure similar to that of the reagent bottle adapter 270 with the main body of the reagent bottle, adopting an idea similar to the opening/closing mechanism according to the first embodiment, for example. Accordingly, a detailed description of an example of the configuration of the dedicated reagent bottle 16 integrated with an opening/closing mechanism similar to the reagent bottle adapter 270 will be omitted.

The reagent bottle adapter 270 is an example of an “opening/closing mechanism” and a “reagent bottle adapter”. The opening/closing mechanism-equipped reagent bottle 16H is an example of a “reagent bottle including an opening/closing mechanism”. The gear part 272p (including the serrated opening/closing portion 272r) is an example of a “gear part”.

As described above, in the automated analyzer 1 according to an embodiment, the opening/closing mechanism of the reagent bottle 16 stored in the first reagent storage 11 or the second reagent storage 12 is operated using the reagent bottle loading device 50 that performs removal, transfer, and storing of the reagent bottle 16 between the first reagent storage 11, the second reagent storage 12, and the reagent replenishment storage (not illustrated). With this configuration, in the automated analyzer 1 according to an embodiment, the opening portion 16p of the reagent bottle 16 can be automatically changed (shifted) to the opened state or the closed state. With this configuration, in the automated analyzer 1 according to the embodiment, the cap of the opening portion 16p of the reagent bottle 16 can be prevented from remaining in the opened state while the analysis (measurement) of a test sample is being performed. Accordingly, in the automated analyzer 1 according to the embodiment, it is possible to reduce factors that may accelerate degradation of reagent quality, such as evaporation of the reagents contained in the reagent bottles 16 during the analysis (measurement) of the sample, which may lead to concentration of the reagent or contamination by other reagents carried through the air.

Furthermore, in the opening/closing mechanism according to an embodiment, a reagent bottle 16 including the opening/closing mechanism can be realized either by forming the opening/closing mechanism integrally with the reagent bottle 16 or by attaching a reagent bottle adapter to the reagent bottle 16. In other words, instead of forming a dedicated reagent bottle 16 including the opening/closing mechanism according to an embodiment, a reagent bottle 16 having an opening/closing mechanism that is equivalent to the dedicated reagent bottle 16 can be realized by attaching a reagent bottle adapter to a general-purpose reagent bottle 160. The operation of the opening/closing mechanism according to an embodiment can be performed using the reagent bottle loading device 50 included in the automated analyzer 1. Moreover, in the opening/closing mechanism according to an embodiment, the cap member portion is provided on the reagent bottle 16 itself. This makes operations such as cleaning the reagent bottle 16 easier than in a configuration in which the cap of the reagent bottle 16 is provided on the analyzing device 10.

In view of the foregoing, in the automated analyzer 1 that performs analysis (measurement) of a test sample in the analyzing device 10 using the reagent bottle 16 including the opening/closing mechanism according to an embodiment, it is possible to perform the analysis (measurement) of the test sample more desirably and more smoothly.

According to at least one embodiment of the above-described embodiments, an automated analyzer is an automated analyzer (1) that performs analysis by mixing a reagent into a test sample to be analyzed, and the automated analyzer (1) includes an analyzing device (10) at least including a reagent bottle holding unit (11 or 12) storing one or a plurality of reagent bottles (16) in which the reagent is stored, a transfer mechanism (50, 52, or 52a) configured to transfer the reagent bottles to the reagent bottle holding unit, and a reagent probe (may include 31, 32, 21, or 22) configured to dispense the reagent in the reagent bottle, and a control unit (may be 144 or 1448) configured to control a component included in the analyzing device, at least when analysis of the test sample is performed, in which the reagent bottle includes an opening/closing mechanism (200, etc.) configured to open or close an opening portion (16p) into which the reagent probe is to be inserted when the reagent is dispensed, and the control unit changes a state of the opening/closing mechanism to an opened state or a closed state by controlling the transfer mechanism. With this configuration, it is possible to provide a configuration of automatically opening or closing the opening portion of the reagent bottle storing the reagent to be used in analysis in the automated analyzer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An automated analyzer that mixes a reagent into a test sample to be analyzed and performs analysis, the automated analyzer comprising:
an analyzing device at least including a reagent bottle holding unit storing one or more reagent bottles in each of which the reagent is stored, a transfer mechanism configured to transfer the one or more reagent bottles to the reagent bottle holding unit, and a reagent probe configured to dispense the reagent in the one or more respective reagent bottles; and
processing circuitry configured to control a component included in the analyzing device at least when analysis of the test sample is performed,
wherein the one or more reagent bottles each include an opening/closing mechanism configured to open or close an opening portion into which the reagent probe is to be inserted when the reagent is dispensed, and
wherein the processing circuitry changes a state of the opening/closing mechanism to an opened state or a closed state by controlling the transfer mechanism.

2. The automated analyzer according to claim 1, wherein the processing circuitry changes the state of the opening/closing mechanism to the opened state or the closed state by causing the transfer mechanism to interfere with a part of the opening/closing mechanism.

3. The automated analyzer according to claim 1,
wherein the reagent bottle holding unit includes an interference unit configured to interfere with a part of the opening/closing mechanism, and
wherein the processing circuitry changes the state of the opening/closing mechanism to the opened state or the closed state by moving a corresponding reagent bottle of the one or more reagent bottles in the reagent bottle holding unit using the transfer mechanism.

4. The automated analyzer according to claim 1,
wherein the reagent bottle holding unit includes an interference unit that interferes with a part of the opening/closing mechanism, and
wherein the processing circuitry changes the state of the opening/closing mechanism to the opened state or the closed state by causing the transfer mechanism to interfere with the interference unit.

5. The automated analyzer according to claim 1,
wherein the opening/closing mechanism includes a magnetic member,
wherein the reagent bottle holding unit includes a magnet portion for attracting the magnetic member, and
wherein the processing circuitry changes the state of the opening/closing mechanism to the opened state or the closed state by moving a corresponding reagent bottle of the one or more reagent bottles in the reagent bottle holding unit using the transfer mechanism.

6. The automated analyzer according to claim 1,
wherein the opening/closing mechanism includes a gear part, and
wherein the processing circuitry changes the state of the opening/closing mechanism to the opened state or the closed state by rotating the gear part by the transfer mechanism.

7. The automated analyzer according to claim 1, wherein the processing circuitry changes the state of the opening/closing mechanism to the opened state or the closed state at any one operation timing of a startup operation of starting up the analyzing device to perform analysis of the test sample, a preparation operation to be performed before analysis is started in the analyzing device, or a shutdown operation for stopping the analyzing device after analysis is completed.

8. The automated analyzer according to claim 7, wherein the processing circuitry changes the state of the opening/closing mechanism to the opened state before the reagent in a corresponding reagent bottle of the one or more reagent bottles is dispensed by the reagent probe.

9. The automated analyzer according to claim 8, wherein the processing circuitry changes the state of the opening/closing mechanism to the closed state after the reagent in a corresponding reagent bottle of the one or more reagent bottles is dispensed by the reagent probe.

10. The automated analyzer according to claim 9, wherein the processing circuitry checks whether dispensing of the reagent in the one or more respective reagent bottles by the reagent probe is enabled, by checking the opened state of the opening/closing mechanism.

11. The automated analyzer according to claim 10, wherein, in a case where dispensing of the reagent is not enabled, the processing circuitry causes a notification apparatus to provide a notification.

12. The automated analyzer according to claim 11, wherein, in a case where dispensing of the reagent is not enabled, the processing circuitry stops analysis of the test sample, or starts analysis of a different test sample without performing analysis of the test sample using the reagent for which dispensing is not enabled.

13. A reagent bottle to be stored in a reagent bottle holding unit included in an analyzing device, in a state in which a reagent to be dispensed by a reagent probe configured to dispense the reagent is contained, in an automated analyzer that mixes the reagent into a test sample to be analyzed to perform analysis, the reagent bottle comprising:
an integrally-formed opening/closing mechanism with which an opened state or a closed state of an opening portion into which the reagent probe is to be inserted is changed by a transfer mechanism configured to transfer the reagent bottle to the reagent bottle holding unit, the transfer mechanism being configured to be controlled by a processing circuitry configured to control a component included in the analyzing device at least when analysis of the test sample is performed.

14. A reagent bottle adapter to be attached to a reagent bottle to be stored in a reagent bottle holding unit included in an analyzing device, in a state in which a reagent to be dispensed by a reagent probe configured to dispense the reagent is contained, in an automated analyzer that mixes the reagent into a test sample to be analyzed to perform analysis, the reagent bottle adapter comprising:
an opening/closing mechanism with which an opened state or a closed state of an opening portion into which the reagent probe is to be inserted is changed by a transfer mechanism configured to transfer the reagent bottle to the reagent bottle holding unit, the transfer mechanism being configured to be controlled by a processing circuitry configured to control a component included in the analyzing device, at least when analysis of the test sample is performed.
